(19) United States
(12) Patent Application Publication
(10) Pub. No.: US 2023/0151167 A1
(43) Pub. Date: May 18, 2023

(54) ANTIMICROBIAL/ANTIVIRAL POLYAMIDE FILM COMPOSITIONS

(71) Applicant: Ascend Performance Materials Operations LLC, Houston, TX (US)

(72) Inventors: Ramesh Ramakrishnan, Houston, TX (US); Jacob G. Ray, Houston, TX (US); Joseph Suriano, Houston, TX (US)

(73) Assignee: Ascend Performance Materials Operations LLC, Houston, TX (US)

(21) Appl. No.: 18/055,451

(22) Filed: Nov. 15, 2022

Related U.S. Application Data
(60) Provisional application No. 63/279,540, filed on Nov. 15, 2021.

(51) Int. Cl. C08J 5/18; C08G 69/14; C08K 3/22; B29C 48/00; B29C 48/08

(52) U.S. Cl. CPC C08J 5/18; C08G 69/14; C08K 3/22; B29C 48/022; B29C 48/08; C08K 2003/2296; B29K 2077/00

(57) ABSTRACT

An antimicrobial film comprising antimicrobial film comprising from 50 wt % to 99.99 wt % of a polyamide composition, and from 10 wppm to 6000 wppm of zinc (and/or copper) dispersed within the film; wherein the film demonstrates: an antimicrobial efficacy to Staphylococcus aureus and Escherichia coli log reduction greater than 2.0, as determined by ISO 22196 (modified), and a slow rate puncture resistance greater than 1.5 N/μm as measured according to ASTM F1306.

### CROSS REFERENCE TO RELATED APPLICATIONS

This application claims priority to U.S. Provisional Application No. 63/279,540, filed Nov. 15, 2021, which is incorporated herein by reference.

### FIELD

The present disclosure relates generally to bio-effective polyamide film compositions having antiviral and antimicrobial properties. In particular, the present disclosure relates to AM/AV polyamide film products, formed from a polyamide composition comprising unique antimicrobial components.

### BACKGROUND

There is a growing interest in antimicrobial and/or antiviral properties (AM/AV) protections for many consumer products. Amid and beyond the COVID-19 pandemic, consumers demand solutions that offer AM/AV protection against microbes, such as in packaging, e.g., food packaging, or as in surface treatments, e.g., wall coverings, keypads, door push plates, touch screens, or screen protectors. Films are one way of protecting these types of products. Such films may be used in many industries including food science, meat, agriculture, healthcare, hospitality, military, and athletics, among others.

In an attempt to achieve these properties, conventional techniques to treat, coat, or otherwise impart antimicrobial properties to films have been explored. These techniques included employing some antimicrobial agents in polymer compositions to combat pathogens such as bacteria, mold, mildew, virus, spores, and fungus. In film applications specifically, (where specific mechanical/chemical properties are required, as compared to fibers or heavy, molded products), these techniques focused on adding some antimicrobial agents to polymers such as polyolefin, polyurethane (PU), polyethylene terephthalate (PET), and/or polyethylene (PE) film. However, many problems persisted with these techniques, including poor mechanical performance and/or deleterious environmental impact.

Thus, a need exists for an AM/AV film that provides adequately antiviral properties to both prevent growth and to actively kill viruses and, at the same time, meets many other mechanical requirements for film applications including, e.g., puncture resistance, crystallization, optical properties, and food safety standards.

### SUMMARY

In some cases, the present disclosure relates to an antimicrobial film comprising from 50 wt % to 99.99 wt % of a polyamide composition, and from 10 wppm to 6000 wppm of zinc (and/or copper) dispersed within the film. The zinc, e.g., as zinc ions, and/or copper, e.g., as copper ions, are dispersed within the film. The antimicrobial film demonstrates an antimicrobial efficacy to Staphylococcus aureus and Escherichia coli log reduction greater than 2.0, as determined by ISO 22196 (modified). The antimicrobial film demonstrates a slow rate puncture resistance greater than 1.5 N/μm as measured according to ASTM F1306. The film may include from 500 wppm to 3000 wppm of zinc (and/or copper) dispersed within the film, or the film may include from 1000 wppm to 2000 wppm of zinc (and/or copper) dispersed within the film. The film may have a thickness less than 0.1 mm, or less than 50 μm, or less than 25 μm.

The polyamide composition may include a polyamide selected from PA6, PA10, PA11, PA12, PA46, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA4T/41; PA4T/61; PAST/5I; PA6,6/6, PA6T/6,6, PA6T/61, PA6T/6I/6, PA6T/6I/6,6, PA6T/DT, PA-6T/MPMDT; PA-6T/6,10; PA10T/6,12; PA10T/10,6; PA6T/6,12; PA6T/10T; PA6T/10I; PA10T/10I; PA10T/12; PA10T/11; PA6T/9T; PA6T/12T; PA6T/10T/61; PA6T/61/12; PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or PAMXD6; and copolymers thereof, terpolymers thereof, blends thereof, mixtures thereof, or combinations thereof. The polyamide composition may include a PA6,6-containing copolyamide. The polyamide composition may include PA6,6/6, PA6,6/6,10, PA6,6/6,12, or combinations thereof. The polyamide composition may include PA6,6/6. The polyamide composition may include PA6,6/6,10, PA6,6/6,12, or combinations thereof. The polyamide composition may include a first polyamide and a second polyamide.

The zinc may be provided from a zinc compound including zinc oxide, zinc stearate, zinc ammonium adipate, zinc acetate, zinc pyrithione, or combinations thereof. The copper may be provided from a copper compound including copper oxide, copper ammonium adipate, copper acetate, copper pyrithione, copper stearate, copper ammonium adipate, or combinations thereof.

The film may have an Mₙ average molecular weight greater than 20,000 g/mol, such as from 20,000 g/mol to 65,000 g/mol. The film may have an Mₙ average molecular weight greater than 25,000 g/mol, such as from 25,000 g/mol to 65,000 g/mol. The film may have an Mₙ average molecular weight greater than 45,000 g/mol. The film may have a relative viscosity in formic acid according to ASTM D789 (9.34) of from 80 to 280. The film may have a viscosity number in sulfuric acid according to ISO 307 of from 190 cc/g to 300 cc/g.

The film may have a difference between the melt temperature Tₘₑₗₜ and the crystallization temperature T_{crystallization} of the film is greater than 50° C. The film may have a difference between the melt temperature Tₘₑₗₜ and the crystallization temperature T_{crystallization} ranging from 50° C. to 125° C.

The film may be a cast film, a blown film, or a biaxially oriented polyamide film. The film may have a tensile strength greater than 25,000 psi. The film may have an elongation at break greater than 50% in the cross direction (TD). The film may have an elongation at break greater than 100% in the machine direction (MD). The film may have a dart drop f-50 greater than 1200 g. The film may be characterized by: a 45° gloss of greater than 75; a transmission of greater than 90%; a haze of greater than 14; and/or a clarity of greater than 94.5. The film may further demonstrate antiviral efficacy.

In some cases, the present disclosure relates to a process for preparing an antimicrobial film comprising melting a polyamide composition including zinc in an extruder to form an antimicrobial film composition and passing the antimicrobial film composition through a film die to form the antimicrobial film. The process may include wherein the polyamide composition including zinc (and/or copper) includes from 50 wt % to 99.99 wt % of a polyamide, and from 10 wppm to 6000 wppm of zinc (and/or copper). The process may further include biaxially orienting the antimicrobial film. The process may further include annealing at a temperature above 60° C.

In some cases, the present disclosure relates an article forms of the antimicrobial film. The article may be a tape. The article may be a food packaging film. The present disclosure relates to an antimicrobial compound comprising zinc present in a film composition in an amount from 10 wppm to 6000 wppm. Other applications are also disclosed herein.

### BRIEF DESCRIPTION OF THE DRAWINGS

FIG. 1 is a graph showing tensile strength performance of exemplary films, as well as that of comparative films.

FIG. 2 is a graph showing elongation performance of exemplary films, as well as that of comparative films.

FIG. 3 is a graph showing puncture resistance performance of exemplary films, as well as that of comparative films.

FIG. 4 is a graph showing dart drop performance of exemplary films, as well as that of comparative films.

FIG. 5 is a graph showing gloss (the capacity of the polymer surface to reflect light in a given direction) performance of exemplary films, as well as that of comparative films.

FIG. 6 is a graph showing transmission percentage performance of exemplary films, as well as that of comparative films.

FIG. 7 is a graph showing haze performance of exemplary films, as well as that of comparative films.

FIG. 8 is a graph showing clarity performance of exemplary films, as well as that of comparative films.

### DETAILED DESCRIPTION

### Introduction

As noted above, some conventional antimicrobial (and/or antiviral) polymer film compositions utilize polymers such as polyolefin, polyurethane, and/or polyethylene film with antimicrobial (and/or antiviral) compounds to inhibit pathogens including bacteria and/or viruses. These conventional films suffer from a multitude of problems, however, including poor mechanical performance and/or deleterious environmental impact. For example, films made from polyolefin polymers have lower tensile strength, lower puncture resistance, lower oxygen and gas barrier performance as compared with polyamide compositions.

For example, some films include polymer/antimicrobial agent combinations. However, it has been found that these polymers may not be suitable for sensitive applications that require human touch and/or food safety and/or may exhibit deleterious effects on puncture resistance and/or tensile strength due to the inclusion of the antimicrobial additives. As one example, the addition of silver to polyolefins results in deleterious environmental impact; and the addition of silver to polyethylene results in a film that lacks the mechanical performance.

The inventors have now found that a synergistic combination of zinc compounds and specific polyamides provides the desired antimicrobial efficacy, e.g., resistant against Staphylococcus aureus and Escherichia coli along with superior mechanical and optical properties. For example, the disclosed films demonstrate an unexpected balance of, inter alia, AM/AV performance, puncture resistance, and clarity, that has not been previously achieved.

The present invention addresses unmet commercial needs by providing polyamide compositions that exhibit an unexpectedly unique combination of thermal, chemical, mechanical, crystallization, optical, and antimicrobial properties that are not otherwise achievable. These polyamide compositions, in some cases, are directed to applications such as cast, blown, and biaxially oriented polyamide (BOPA) films (and monoloyer and multilayer configurations thereof). Key target areas include industrial or food applications that require monolayer or multilayer packages. Examples of uses of monolayer film applications include, but are not limited to, vacuum bagging/protective films for curing composite structures, e.g., windmill blades for wind energy, cooking bags. Examples of uses of such a multilayer blown film include, but are not limited to, meat and cheese packaging and stand-up pouches, and shrink films for bone-in meats.

Without being bound by theory, when the disclosed AM/AV compounds are employed with the polyamides, the compounds interact such that increased hydrophilicity and/or hygroscopy both may better attract liquid and/or capture media that carry microbials and/or viruses.

In some cases, the disclosed polyamide compositions are formulated to have lower crystallinity, lower crystallization rates, higher melting temperatures, and higher molecular weights. To the latter point, film applications typically have number average molecular weight (Mₙ) values of greater than 20,000 g/mol, greater than 25,000 g/mol, or greater than 45,000 g/mol, as compared to other applications, e.g., fibers or heavy molded products, which require lower Mₙ values. The conventional teachings relating to non-film applications relate to a different set of performance characteristics, and these teachings are not relevant to film formulation.

In one aspect, an AM/AV film is disclosed. The film is made of/from or comprises a particular polymer composition. The composition includes from 50 wt % to 99.99 wt % of a polyamide composition, and from 10 wppm to 6000 wppm of zinc dispersed within the film. Additional details of the zinc and polyamide components are disclosed herein. As noted above, the film demonstrates a synergistic balance of performance features, e.g., an antimicrobial efficacy to Staphylococcus aureus and Escherichia coli log reduction greater than 2.0 and a slow rate puncture resistance greater than 1.5 N/μm as measured according to ASTM F1306.

The disclosed polyamide compositions are particularly germane to film production. As noted above, film formulations requires specific chemistry and characteristics that are not required or even desired for other applications.

The components of the bio-effective polyamide film composition are now discussed individually. It is contemplated that these components may be employed with one another to form the aforementioned bio-effective polyamide film compositions.

### Polyamide Polymers

The inventors have found that the disclosed polyamides demonstrate unexpected performance benefits over conventional polymers such as polyolefin, polyurethane, polyethylene terephthalate, and polyethylene polymers for film applications due to at least their mechanical performance, thermal properties, and for their food safe and environmental compatibility. Polyamide films can be formulated to have high puncture resistance and high tensile strength while maintaining optical properties such as clarity. In addition, the polyamide compositions herein are especially beneficial for films, as opposed to non-woven, fiber, and/or molded products, because of their slow crystallization rates. The present polyamides provide for a difference between melting point and crystallization temperature that is much higher and thus suitable for film applications as compared to non-woven, fiber, and/or molded products.

The polyamide of the disclosed compositions can vary widely and can include one polyamide polymer or two or more polyamide polymers. Exemplary polyamides and polyamide compositions are described in Kirk-Othmer, Encyclopedia of Chemical Technology, Vol. 18, pp. 328-371 (Wiley 1982), the disclosure of which is incorporated by reference. Briefly, polyamides are products that contain recurring amide groups as integral parts of the main polymer chains. Linear polyamides are of particular interest and may be formed from condensation of bifunctional monomers as is well known in the art. Polyamides are frequently referred to as nylons. Particular polyamide polymers and copolymers and their preparation are described in, for example, U.S. Pat. Nos. 2,071,250; 2,071,251; 2,130,523; 2,130,948; 2,241,322; 2,312,966; 2,512,606; 3,236,914; 3,472,916; 3,373,223; 3,393,210; 3,984,497; 3,546,319; 4,031,164; 4,320,213; 4,346,200; 4,713,415; 4,760,129; 4,981,906; 5,504,185; 5,543,495; 5,698,658; 6,011,134; 6,136,947; 6,169,162; 6,197,855; 7,138,482; 7,381,788; and 8,759,475, each of which is incorporated by reference in entirety for all purposes.

Polyamides of the present disclosure include nylons, aramids, aliphatic polyamides, semi-aromatic polyamides, polyphthalamides, and combinations thereof. The polyamide composition can include one or more polyamides such as PA6, PA10, PA11, PA12, PA46, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA4T/4I; PA4T/6I; PAST/5I; PA6,6/6, PA6T/6,6, PA6T/6I, PA6T/61/6, PA6T/6I/6,6, PA6T/DT, PA-6T/MPMDT (where MPMDT is polyamide based on a mixture of hexamethylene diamine and 2-methylpentamethylene diamine as the diamine component and terephthalic acid as the diacid component); PA-6T/6,10; PA10T/6,12; PA10T/10,6; PA6T/6,12; PA6T/10T; PA6T/10I; PA10T/10I; PA10T/12; PA10T/11; PA6T/9T; PA6T/12T; PA6T/10T/6I; PA6T/61/12; PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or PAMXD6 and copolymers, terpolymers, blends, mixtures and/or other combinations thereof. In some embodiments, the polyamides herein disclosed include a PA6,6-based copolymer such as PA6,6/6, PA6,6/6,10, PA6,6/6,12, or combinations thereof, which demonstrate a slow rate of crystallization which helps with processing, ease of stretching, and orienting polymer chains. These films also provide excellent mechanical properties such as puncture resistance and toughness.

Film formulations require higher number average molecular weight values than for conventional molded parts, for example. And the relative viscosities associated with the particular Mₙ are characteristics of the polyamide. Polyamides herein are selected based on these characteristics. The ranges and limits as provided in the discussion below for number average molecular weight and relative viscosity are applicable to both the polyamide composition and for the antimicrobial film as a whole. The disclosed polyamide compositions are able to maintain desired relative viscosity levels, which provides for advantageous processing benefits. Furthermore, the conventional additives added to polymer compositions to impart antimicrobial properties in films made therefrom have been found to reduce the relative viscosity in the polymer compositions. This reduced relative viscosity produces further difficulty in film processing from the polyamide composition, e.g., increased difficulty during extrusion.

Such polymers may synergistically work well with the other components of the polyamide composition due to the hydrophilic and/or hygroscopic properties thereof. The polyamide compositions surprisingly may benefit from a polymer having high or increased hydrophilicity and/or hygroscopy. In particular, the use of a hydrophilic and/or hygroscopic polymer may increase the antimicrobial (and/or antiviral) properties of the polyamide composition. It is postulated that microbials and/or viruses are carried by liquids like saliva and mucous. Also, it is theorized that a polymer of increased hydrophilicity and/or hygroscopy both may better attract liquid media that carry microbials and/or viruses, e.g., saliva or mucous, and may also absorb more moisture, e.g., from the air, and that the increased moisture content allows the polyamide composition and the antiviral/antimicrobial agent to more readily limit, reduce, or inhibit infection and/or pathogenesis of a virus. For example, the moisture may dissolve an outer layer, e.g., capsid, of a virus, exposing the genetic material, e.g., DNA or RNA, of the virus. The exposed genetic material is more susceptible to deactivation by other components of the polyamide composition, e.g., the zinc compound (discussed below). This is one surprising, synergistic result of using polymers having higher levels of hydrophilicity and/or hygroscopy. In contrast, films formed from less hydrophilic and/or hygroscopic polymers, e.g., polypropylene, may not attract the fluids, and may not be as effective.

In some cases, conventional surface modifiers, such as citric acid, are applied to or sprayed on the surface of the polyamide compositions (or of films or articles formed therefrom). By using a hydrophilic and/or hygroscopic polymer, the polyamide compositions of the present disclosure may not require any such solubility modifiers.

In some other embodiments, however, the films or articles formed from the polyamide compositions may be treated, e.g., with citric acid, to make them even more hydrophilic and/or hygroscopic.

In some cases, the hydrophilicity and/or hygroscopy of a polymer may be measured by saturation.

In some cases, the hydrophilicity and/or hygroscopy of a polymer may be measured by the amount of water it can absorb (as a percentage of total weight). In some embodiments, the hydrophilic and/or hygroscopic polymer is capable of absorbing greater than 1.5 wt % water, based on the total weight of the polymer, e.g., greater than 2.0 wt %, greater than 3.0 wt %, greater than 5.0 wt %, or greater than 7.0 wt %. In terms of ranges, the hydrophilic and/or hygroscopic polymer may be capable of absorbing water in an amount ranging from 1.5 wt % to 10.0 wt %, e.g., from 1.5 wt % to 9.0 wt %, from 2.0 wt % to 8 wt %, from 2.0 wt % to 7 w %, of from 2.5 wt % to 7 wt %. The ability to absorb more moisture allows the polyamide compositions to better reduce or inhibit the growth of the microbials and/or viruses that are contained therein (as discussed above).

As noted above, some applications of the polyamide compositions described herein surprisingly may benefit from increased hygroscopy. An increase in hygroscopy may be achieved in the selection and/or modification the polymer. In some embodiments, the polymer may be a common polymer, e.g., a common polyamide, which has been modified to increase hygroscopy. In these embodiments, a functional end group modification on the polymer may increase hygroscopy. For example, the polymer may be PA6,6, which has been modified to include a functional end group that increases hygroscopy.

The polyamide composition may, in some embodiments, comprise a combination of polyamides. By combining various polyamides, the final composition may be able to incorporate the desirable properties, e.g., mechanical properties, of each constituent polyamides. For example, in some embodiments, the polyamide comprises a combination of PA6,6/6, PA6,6/6,10, and PA6,6/6,12. In these embodiments, the polyamide may comprise from 1 wt % to 99 wt % PA6,6/6, from 1 wt % to 99 wt % PA6,6/6,10, and from 1 wt % to 99 wt % PA6,6/6,12. In some embodiments, the polyamide comprises one or more of PA6,6/6, PA6,6/6,10, and PA6,6/6,12. In some cases, these copolymers including long chain polyamides demonstrate particularly synergistic results. In some aspects, the polyamide composition comprises copolymers or blends of any of the polyamides mentioned herein.

The polyamide composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt % caprolactam, e.g., at least 15 wt %, at least 20 wt %, at least 25 wt %, at least 30 wt %, at least 35 wt %, at least 40 wt %, at least 45 wt %, at least 50 wt %, at least 55 wt %, or at least 60 wt %. In some embodiments, the polymer includes from 10 wt % to 60 wt % of caprolactam, e.g., from 15 wt % to 55 wt %, from 20 wt % to 50 wt %, from 25 wt % to 45 wt %, or from 30 wt % to 40 wt %. In some embodiments, the polymer comprises less than 60 wt % caprolactam, e.g., less than 55 wt %, less than 50 wt %, less than 45 wt %, less than 40 wt %, less than 35 wt %, less than 30 wt %, less than 25 wt %, less than 20 wt %, or less than 15 wt %. Furthermore, the polyamide composition may comprise the polyamides produced through the copolymerization of a lactam with a nylon, for example, the product of the copolymerization of a caprolactam with PA-6,6.

In some aspects, the antimicrobial film can be formed by conventional polymerization of the polyamide composition and film processing in which an aqueous solution of at least one diamine-carboxylic acid salt is heated to remove water and effect polymerization to form an antimicrobial and/or antiviral nylon. This aqueous solution is preferably a mixture which includes at least one polyamide-forming salt in combination with the specific amount of a zinc compound described herein to produce a polyamide film composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

The antimicrobial film comprises a polyamide composition as the major component. In one embodiment, the antimicrobial film comprises a polyamide composition in an amount ranging from 50 wt % to 99.99 wt %, e.g., from 55 wt % to 99.99 wt %, from 60 wt % to 99.99 wt %, from 65 wt % to 99.99 wt %, from 70 wt % to 99.99 wt %, from 75 wt % to 99.99 wt %, from 80 wt % to 99.99 wt %, from 85 wt % to 99.99 wt %, from 90 wt % to 99.99 wt %, from 95 wt % to 99.99 wt %, from 96 wt % to 99.99 wt %, from 97 wt % to 99.99 wt %, from 98 wt % to 99.99 wt %, from 99 wt % to 99.99 wt %, from 99.5 wt % to 99.99 wt %, or from 99.9 wt % to 99.99 wt %.

In terms of lower limits, the antimicrobial film may comprise greater than 50 wt % polyamide composition, e.g., greater than 55 wt %, greater than 60 wt %, greater than 65 wt %, greater than 70 wt %, greater than 75 wt %, greater than 80 wt %, greater than 85 wt %, greater than 90 wt %, greater than 95 wt %, greater than 96 wt %, greater than 97 wt %, greater than 98 wt %, greater than 99 wt %, greater than 99.5 wt %, or greater than 99.9 wt %.

In terms of upper limits, the antimicrobial film may comprise less than 100 wt % polyamide composition, e.g., less than 99.99 wt %, less than 99.9 wt %, less than 99.5 wt %, less than 99 wt %, less than 98 wt %, less than 97 wt %, less than 96 wt %, less than 95 wt %, less than 90 wt %, or less than 85 wt %.

The antimicrobial film may comprise less than 1 wt % of non-polyamide polymers, e.g., polyolefin, polyethylene, polyethylene terephthalate, or combinations thereof. In terms of upper limits, the antimicrobial film may comprise less than 1 wt % of non-polyamide polymers, e.g., less than 0.5 wt %, less than 0.1 wt %, less than 0.005 wt %, or less than 0.001 wt %.

In some embodiments, the polyamide compositions (and the films and articles produced therefrom) advantageously comprise little or no content of processing aids or additives, such as surfactants, coupling agents, lubricants, impact modifiers, plasticizers, colorants, or glass. Adding these components to film formulations would only add additional cost and complicate processing for little or no benefit.

(Some of) these components mentioned herein, in some case, may be considered optional. In some cases, the disclosed compositions may expressly exclude one or more of the aforementioned components in this section, e.g., via claim language. For example claim language may be modified to recite that the disclosed compositions, processes, etc., do not utilize or comprise one or more of the aforementioned components, e.g., the compositions do not include a plasticizer or an impact modifier.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some cases, the polyamide compositions comprise less than 100 wppm processing aids or additives, e.g., less than 50 wppm, less than less than 20 wppm, less than 10 wppm, or less than 5 wppm. In terms of ranges, the polyamide compositions may comprise from 1 wppb to 100 wppm, e.g., from 1 wppb to 20 wppm, from 1 wppb to 10 wppm, or from 1 wppb to 5 wppm. The disclosed compositions may not employ any processing aids or additives at all. There can be no processing aids or additives present after processing, which is not the case for conventional non-film formulations that do employ surfactant and/or coupling agents as necessary components.

The inventors have found that the content of amine end groups (AEG) may have a surprising effect on the performance of the polyamide compositions, films, and articles. As one example, the amine end groups have been found to improve the ability of films to adhere to the other layers in a multilayer film construction. The polyamide composition may have an AEG content ranging from 1 μeq/gram to 105 μeq/gram, e.g., from 1 μeq/gram to 75 μeq/gram, from 1 μeq/gram to 55 μeq/gram, from 5 μeq/gram to 50 μeq/gram, or from 15 μeq/gram to 40 μeq/gram. In terms of upper limits, the polymer composition may have an AEG content less than 105 μeq/gram, e.g., less than 100 μeq/gram, less than 90 μeq/gram, less than 75 μeq/gram, less than 55 μeq/gram, less than 50 μeq/gram, less than 45 μeq/gram, less than 40 μeq/gram, less than 35 μeq/gram, less than 30 μeq/gram, or less than 25 μeq/gram. In terms of lower limits, the polymer composition may have an AEG content greater than 1 μeq/gram, e.g., greater than 5 μeq/gram, greater than 10 μeq/gram, greater than 15 μeq/gram, greater than 20 μeq/gram, greater than 25 μeq/gram, greater than 35 μeq/gram, greater than 40 μeq/gram, or greater than 50 μeq/gram.

### AM/AV Compounds

As noted above, the antimicrobial film comprises a polyamide composition and zinc in a zinc compound, preferably in specific amounts in the film, to provide the aforementioned structural and antimicrobial and/or antiviral benefits. As used herein, “zinc compound” refers to a compound having at least one zinc molecule or ion. Zinc content may be indicated by zinc or zinc ion. The ranges and limits may be employed for zinc content and for zinc ion content. The calculation of zinc ion content based on zinc or zinc compound can be made by the skilled chemist, and such calculations and adjustments are contemplated.

The antimicrobial/antiviral compound may additionally or alternatively include copper in a copper compound. As used herein, “copper compound” refers to a compound having at least one copper molecule or ion. Similarly as for zinc, copper content may be indicated by copper or copper ion. The ranges and limits employed for zinc content and for zinc ion content, apply to other metal content, e.g., copper content. The calculation of copper ion content based on copper or copper compound can be made by the skilled chemist, and such calculations and adjustments are contemplated.

The inventors have found that the use of specific zinc compounds (and the zinc contained therein) at specific molar ratios minimizes the negative effects of the zinc compound on the film. For example, too much zinc compound combined with the polyamide composition can lead to decreased viscosity and inefficiencies in antimicrobial film production processes. Higher zinc content negatively impacts antimicrobial film production processing by decreasing melt strength and melt viscosity.

The antimicrobial film may comprise zinc (e.g., in a zinc compound or as zinc ion), e.g., zinc or a zinc compound, expressed in parts per million on a weight basis (wppm), dispersed within the antimicrobial film and/or dispersed within the polyamide composition. In one embodiment, the antimicrobial film comprises zinc in an amount ranging from 10 wppm to 6000 wppm of zinc or from 10 wppm to 5500 wppm zinc, e.g., from 10 wppm to 5000 wppm, from 10 wppm to 4500 wppm, from 10 wppm to 4000 wppm, from 10 wppm to 3500 wppm, from 10 wppm to 3000 wppm, from 10 wppm to 2500 wppm, from 10 wppm to 2000 wppm, from 10 wppm to 1500 wppm, from 500 wppm to 5500 wppm, from 500 wppm to 4500 wppm, from 500 wppm to 4000 wppm, from 500 wppm to 3500 wppm, from 500 wppm to 3000 wppm, from 500 wppm to 2500 wppm, from 500 wppm to 2000 wppm, from 500 wppm to 1500 wppm, from 1000 wppm to 5500 wppm, from 1000 wppm to 5000 wppm, from 1000 wppm to 4500 wppm, from 1000 wppm to 4000 wppm, from 1000 wppm to 3500 wppm, from 1000 wppm to 3000 wppm, from 1000 wppm to 2500 wppm, from 1000 wppm to 2000 wppm, or from 1000 wppm to 1500 wppm.

In terms of lower limits, the antimicrobial film may comprise greater than 10 wppm of zinc, e.g., greater than 20 wppm, greater than 50 wppm, greater than 100 wppm, greater than 200 wppm, greater than 300 wppm, greater than 400 wppm, greater than 500 wppm, greater than 600 wppm, greater than 700 wppm, greater than 800 wppm, greater than 900 wppm, or greater than 1,000 wppm.

In terms of upper limits, the antimicrobial film may comprise less than 6000 wppm of zinc, e.g., less than 5500 wppm, less than 5000 wppm, less than 4500 wppm, less than 4000 wppm, less than 3500 wppm, less than 3000 wppm, less than 2500 wppm, less than 2000 wppm, less than 1500 wppm, less than 1000 wppm, less than 500 wppm. In some aspects, the zinc compound is embedded in the antimicrobial film formed from the polyamide composition.

In other embodiments, the antimicrobial film comprises zinc in an amount ranging from 100 wppm to 6000 wppm, e.g., from 100 wppm to 5500 wppm, from 100 wppm to 5000 wppm, from 100 wppm to 4500 wppm, from 100 wppm to 4000 wppm, from 100 wppm to 3500 wppm, from 100 wppm to 3000 wppm, from 100 wppm to 2500 wppm, from 100 wppm to 2000 wppm, from 500 wppm to 6000 wppm, from 500 wppm to 5500 wppm, from 500 wppm to 5000 wppm, from 500 wppm to 4500 wppm, from 500 wppm to 4000 wppm, from 500 wppm to 3500 wppm, from 500 wppm to 3000 wppm, from 500 wppm to 2500 wppm, from 500 wppm to 2000 wppm, from 1000 wppm to 6000 wppm, from 1000 wppm to 5500 wppm, from 1000 wppm to 5000 wppm, from 1000 wppm to 4500 wppm, from 1000 wppm to 4000 wppm, from 1000 wppm to 3500 wppm, from 1000 wppm to 3000 wppm, from 1000 wppm to 2500 wppm, from 1000 wppm to 2000 wppm, from 1500 wppm to 6000 wppm, from 1500 wppm to 5500 wppm, from 1500 wppm to 5000 wppm, from 1500 wppm to 4500 wppm, from 1500 wppm to 4000 wppm, from 1500 wppm to 3500 wppm, from 1500 wppm to 3000 wppm, from 1500 wppm to 2500 wppm, or from 1750 wppm to 2225 wppm.

In terms of lower limits, the antimicrobial film may comprise greater than 100 wppm of zinc, e.g., greater than 200 wppm, greater than 300 wppm, greater than 400 wppm, greater than 500 wppm, greater than 600 wppm, greater than 700 wppm, greater than 800 wppm, greater than 900 wppm, greater than 1000 wppm, greater than 1500 wppm, or greater than 1750 wppm.

In terms of upper limits, the antimicrobial film may comprise less than 6000 wppm of zinc, e.g., less than 5500 wppm, less than 5000 wppm, less than 4500 wppm, less than 4000 wppm, less than 3500 wppm, less than 3000 wppm, less than 2500 wppm, less than 1750 wppm, or less than 1500 wppm. In some aspects, the zinc is present in an amount of about 2000 wppm in the antimicrobial film formed from the polyamide composition.

The ranges and limits are applicable to both zinc in elemental or ionic form and to zinc compound. For example, the ranges may relate to the amount of zinc ions dispersed in the polyamide.

The zinc of the antimicrobial film is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate.

The inventors have also found that the antimicrobial film surprisingly may benefit from the use of specific zinc compounds. In particular, the use of zinc compounds prone to forming ionic zinc (e.g., Zn2+) may increase the antimicrobial and/or antiviral properties of the polyamide composition. It is theorized that the ionic zinc disrupts the replicative cycle of the pathogen. For example, the ionic zinc may interfere with (e.g., inhibit) viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLoS Pathogens (November 2010), which is incorporated herein by reference.

The amount of the zinc compound present in the antimicrobial film may be discussed in relation to the ionic zinc content. In one embodiment, the film comprises ionic zinc, e.g., Zn²⁺, in an amount ranging from 1 ppm to 30,000 ppm, e.g., from 1 ppm to 25,000 ppm, from 1 ppm to 20,000 ppm, from 1 ppm to 15,000 ppm, from 1 ppm to 10,000 ppm, from 1 ppm to 5,000 ppm, from 1 ppm to 2,500 ppm, from 50 ppm to 30,000 ppm, from 50 ppm to 25,000 ppm, from 50 ppm to 20,000 ppm, from 50 ppm to 15,000 ppm, from 50 ppm to 10,000 ppm, from 50 ppm to 5,000 ppm, from 50 ppm to 2,500 ppm, from 100 ppm to 30,000 ppm, from 100 ppm to 25,000 ppm, from 100 ppm to 20,000 ppm, from 100 ppm to 15,000 ppm, from 100 ppm to 10,000 ppm, from 100 ppm to 5,000 ppm, from 100 ppm to 2,500 ppm, from 150 ppm to 30,000 ppm, from 150 ppm to 25,000 ppm, from 150 ppm to 20,000 ppm, from 150 ppm to 15,000 ppm, from 150 ppm to 10,000 ppm, from 150 ppm to 5,000 ppm, from 150 ppm to 2,500 ppm, from 250 ppm to 30,000 ppm, from 250 ppm to 25,000 ppm, from 250 ppm to 20,000 ppm, from 250 ppm to 15,000 ppm, from 250 ppm to 10,000 ppm, from 250 ppm to 5,000 ppm, or from 250 ppm to 2,500 ppm. In some cases, the ranges and limits mentioned above for zinc may also be applicable to ionic zinc content.

In other embodiments, the antimicrobial film comprises zinc oxide in an amount ranging from 100 wppm to 6500 wppm, e.g., from 100 wppm to 6000 wppm, from 100 wppm to 5500 wppm, from 100 wppm to 5000 wppm, from 100 wppm to 4500 wppm, from 100 wppm to 4000 wppm, from 100 wppm to 3500 wppm, from 100 wppm to 3000 wppm, from 100 wppm to 2500 wppm, from 500 wppm to 6500 wppm, from 500 wppm to 6000 wppm, from 500 wppm to 5500 wppm, from 500 wppm to 5000 wppm, from 500 wppm to 4500 wppm, from 500 wppm to 4000 wppm, from 500 wppm to 3500 wppm, from 500 wppm to 3000 wppm, from 500 wppm to 2500 wppm, from 1000 wppm to 6500 wppm, from 1000 wppm to 6000 wppm, from 1000 wppm to 5500 wppm, from 1000 wppm to 5000 wppm, from 1000 wppm to 4500 wppm, from 1000 wppm to 4000 wppm, from 1000 wppm to 3500 wppm, from 1000 wppm to 3000 wppm, from 1000 wppm to 2500 wppm, from 2000 wppm to 6500 wppm, from 2000 wppm to 6000 wppm, from 2000 wppm to 5500 wppm, from 2000 wppm to 5000 wppm, from 2000 wppm to 4500 wppm, from 2000 wppm to 4000 wppm, from 2000 wppm to 3500 wppm, from 2000 wppm to 3000 wppm, or from 2250 wppm to 2750 wppm.

In terms of lower limits, the antimicrobial film may comprise greater than 100 wppm of zinc oxide, e.g., greater than 200 wppm, greater than 300 wppm, greater than 400 wppm, greater than 500 wppm, greater than 600 wppm, greater than 700 wppm, greater than 800 wppm, greater than 900 wppm, greater than 1000 wppm, greater than 1500 wppm, or greater than 2000 wppm, or greater than 2250 wppm.

In terms of upper limits, the antimicrobial film may comprise less than 6500 wppm of zinc oxide, e.g., less than 6500 wppm, less than 6000 wppm, less than 5500 wppm, less than 5000 wppm, less than 4500 wppm, less than 4000 wppm, less than 3500 wppm, less than 3000 wppm, or less than 2750 wppm. In some aspects, the zinc oxide is present in an amount of about 2500 wppm in the antimicrobial film formed from the polyamide composition.

It has been determined that a specific amount of the zinc compound can be mixed in a antimicrobial film, e.g., in a polyamide composition, in finely divided form, such as in the form of granules, flakes and the like, to provide a polymer composition that can be subsequently formed, e.g., extruded by conventional methods to produce films having substantially improved antimicrobial activity. The zinc is employed in the polyamide composition in the aforementioned amounts to provide a film with improved antimicrobial activity retention (near-permanent).

The ranges and limits employed for zinc content and for zinc ion content as above apply to other copper content as well.

In some embodiments, the antimicrobial film may comprise less than 1 wt % of non-zinc (or non-copper) metals, e.g., silver. In terms of upper limits, the antimicrobial film may comprise less than 1 wt % of non-zinc metals (or non-copper), e.g., less than 0.5 wt %, less than 0.1 wt %, less than 0.005 wt %, or less than 0.001 wt %.

As noted above, the polymer composition, in some embodiments, includes copper (provided via a copper compound). As used herein, “copper compound” refers to a compound having at least one copper molecule or ion.

The polymer composition may comprise copper (e.g., in a copper compound), e.g., copper or a copper compound, dispersed within the polymer composition in the amounts as detailed for zinc content above.

The composition of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate.

In some cases, the copper compound may improve, e.g., enhance the antiviral properties of the polymer composition. In some cases, the copper compound may affect other characteristics of the polymer composition, e.g., antimicrobial activity or physical characteristics. In some embodiments, both zinc and copper are used synergistically for enhanced antimicrobial activity.

In one embodiment, the molar ratio of the copper to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to copper in the polymer composition may be less than 15:1, e.g., less than 10:1, less than 9:1, less than 8:1, less than 7:1, less than 6:1, less than 5:1, less than 4:1, or less than 3:1. In some cases, copper is bound in the polymer matrix along with zinc.

In some embodiments, the use of cuprous ammonium adipate has been found to be particularly effective in activating copper ions into the polymer matrix. It is found that dissolving copper (I) or copper (II) compounds in ammonium adipate is particularly efficient at generating copper (I) or copper (II) ions.

### Zinc/Copper Retention Rate

As noted herein, by utilizing a polymer composition having the aforementioned zinc compound and/or copper compound in the disclosed concentrations, the resultant antimicrobial film is capable of retaining a higher percentage of zinc and/or copper, even after additional processing or treatments, such as surface treatment and/or printing onto the antimicrobial films. The resulting films formed even undergoing additional processing or surface treatments have antimicrobial properties.

In some embodiments, the antimicrobial film formed from the polyamide compositions have a zinc and/or copper retention greater than 65%, e.g., greater than 75%, greater than 80%, greater than 90%, greater than 95%, greater than 97%, greater than 98%, greater than 99%, greater than 99.9%, greater than 99.99%, greater than 99.999%, greater than 99.9999%, greater than 99.99999% or greater than 99.999999%. In terms of upper limits, the antimicrobial film has a zinc and/or copper retention of less than 100%, e.g., less than 99.9%, less than 98%, or less than 95%. In terms of ranges, the antimicrobial film has a zinc and/or copper retention may be from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%.

In some embodiments, the antimicrobial film (or other antimicrobial products formed therefrom) formed from the polyamide compositions have a zinc and/or copper retention greater than 40%, e.g., greater than 44%, greater than 45%, greater than 50%, greater than 55%, greater than 60%, greater than 65%, greater than 70%, greater than 75%, greater than 80%, greater than 90%, greater than 95%, or greater than 99%. In terms of upper limits, the antimicrobial films may have a zinc and/or copper retention of less than 100%, e.g., less than 99.9%, less than 98%, less than 95% or less than 90%. In terms of ranges, the antimicrobial film has a zinc and/or copper retention in a range from 40% to 100%, e.g., from 45% to 99.9%, from 50% to 99.9%, from 75% to 99.9%, from 80% to 99%, or from 90% to 98%.

In some embodiments, the antimicrobial film (or other antimicrobial products formed therefrom) formed from the polyamide compositions have a zinc and/or copper retention greater than 20%, e.g., greater than 24%, greater than 25%, greater than 30%, greater than 35%, greater than 40%, greater than 45%, greater than 50%, greater than 55%, or greater than 60%. In terms of upper limits, the antimicrobial films may have a zinc and/or copper retention of less than 80%, e.g., less than 77%, less than 75%, less than 70%, less than 68%, or less than 65%. In terms of ranges, the antimicrobial films may have a zinc and/or copper retention ranging from 20% to 80%, e.g., from 25% to 77%, from 30% to 75%, or from 35% to 70%.

Stated another way, in some embodiments, the antimicrobial film (or other antimicrobial products formed therefrom) formed from the polyamide compositions demonstrate an extraction rate of the zinc and/or copper compound less than 35%, e.g., less than 25%, less than 20%, less than 10%, or less than 5%. In terms of upper limits, the antimicrobial film demonstrates an extraction rate of the zinc and/or copper compound greater than 0%, e.g., greater than 0.1%, greater than 2% or greater than 5%. In terms of ranges, the antimicrobial film demonstrates an extraction rate of the zinc and/or copper compound from 0% to 35%, e.g., from 0% to 25%, from 0% to 20%, from 0% to 10%, from 0% to 5%, from 0.1% to 35%, from 0.1% to 25%, from 0.1% to 20%, from 0.2% to 10%, from 0.1% to 5%, from 2% to 35%, from 2% to 25%, from 2% to 20%, from 2% to 10%, from 2% to 5%, from 5% to 35%, from 5% to 25%, from 5% to 20%, or from 5% to 10%.

In some embodiments, the zinc and/or copper retention of a antimicrobial film formed from the polyamide composition may be calculated by measuring zinc and/or copper content before and after a dye bath operation. The amount of zinc and/or copper retained after the dye bath may be measured by known methods. For the dye bath, an Ahiba dyer (from Datacolor) may be employed. In a particular instance, twenty grams of un-dyed fabric and 200 ml of dye liquor may be placed in a stainless steel can, the pH may be adjusted to the desired level, the stainless steel can may be loaded into the dyer; the sample may be heated to 40° C. then heated to 100° C. (optionally at 1.5° C./minute). In some cases a temperature profile may be employed, for example, 1.5° C./minute to 60° C., 1° C./minute to 80° C., and 1.5° C./minute to 100° C. The sample may be held at 100° C. for 45 minutes, followed by cooling to 40° C. at 2° C./minute, then rinsed and dried to yield the dyed product.

In addition to the antimicrobial/antiviral properties, the disclosed compositions surprisingly demonstrate improved zinc and/or copper retention after surface treatment which may include cleaning the surface, e.g., autoclave or steam sterilization, or any surface treatment or printing onto the film, which may include solvents. The zinc retention may be characterized in relation to surface treatment. The films are capable of retaining a higher percentage of zinc and/or copper, even after surface treatments, as such the resulting films formed retain AM/AV properties.

### Master Batch Formulations

As discussed above, polyamide compositions described herein (including AM/AV compounds) may comprise a combination of polyamides for use in film applications as made in a melt polymerization with, optionally, a solid state polymerization (SSP) process to improve the mechanical and rheological properties. In other embodiments, the polyamide compositions can be added to form a master batch in a master batch process that is used to form a film product. The polyamide compositions herein can also be used to prepare antimicrobial master batch compositions to impart AM/AV effects in formulations. For example, a formulation comprising conventional polymers (that do not contain AM/AV compound) can employ an antimicrobial master batch composition including polyamide compositions described herein (that do contain AM/AV compound) to provide antimicrobial and/or antiviral effects to the entire formulation. Using an antimicrobial master batch composition as described herein provides ease of processing and flexibility as an attractive alternative to having to produce formulations by fully compounding from raw materials on site.

The antimicrobial master batch composition can have a higher concentration (in comparison with the target formulation) of AM/AV compounds. There can be several advantages to using an antimicrobial master batch composition in formulations. Firstly, the relatively dilute nature of the antimicrobial master batch composition (in comparison with raw AM/AV compounds) allows higher accuracy in dosing in subsequent target formulations. Also using an antimicrobial master batch composition as herein described allows for sourcing less stock of the antimicrobial master batch compositions to use with stocked (and less expensive) conventional polymers.

Any of the polyamides discussed above may be used in antimicrobial master batch compositions. In some embodiments, antimicrobial master batch compositions comprise from 1 wt % to 99 wt % PA6,6/6, from 1 wt % to 99 wt % PA6,6/6,10, and from 1 wt % to 99 wt % PA6,6/6,12 and an antimicrobial compound, such as any described above, in the amounts as follows. In some embodiments, the antimicrobial master batch compositions comprise at least 50 wt % to 99 wt % PA6,6/6, PA6,6/6,10, PA6,6/6,12, and combinations thereof, and an antimicrobial compound, such as any described above, in the amounts as follows.

Formulations made with antimicrobial master batch compositions may comprise 50 wt % to 90 wt % antimicrobial master batch composition (containing AM/AV compound) and 10 wt % to 50 wt % another polymer (containing no AM/AV compound). The formulations preferably comprise the antimicrobial master batch composition as the major component. In one embodiment, the formulation includes antimicrobial master batch composition in an amount ranging from 50 wt % to 99.99 wt %, e.g., from 55 wt % to 99.99 wt %, from 60 wt % to 99.99 wt %, from 65 wt % to 99.99 wt %, from 70 wt % to 99.99 wt %, from 75 wt % to 99.99 wt %, from 80 wt % to 99.99 wt %, from 85 wt % to 99.99 wt %, from 90 wt % to 99.99 wt %, from 95 wt % to 99.99 wt %, from 96 wt % to 99.99 wt %, from 97 wt % to 99.99 wt %, from 98 wt % to 99.99 wt %, from 99 wt % to 99.99 wt %, from 99.5 wt % to 99.99 wt %, or from 99.9 wt % to 99.99 wt %.

In terms of lower limits, the formulation may comprise greater than 50 wt % antimicrobial master batch composition, e.g., greater than 55 wt %, greater than 60 wt %, greater than 65 wt %, greater than 70 wt %, greater than 75 wt %, greater than 80 wt %, greater than 85 wt %, greater than 90 wt %, greater than 95 wt %, greater than 96 wt %, greater than 97 wt %, greater than 98 wt %, greater than 99 wt %, greater than 99.5 wt %, or greater than 99.9 wt %.

In terms of upper limits, the formulation may comprise less than 100 wt % antimicrobial master batch composition, e.g., less than 99.99 wt %, less than 99.9 wt %, less than 99.5 wt %, less than 99 wt %, less than 98 wt %, less than 97 wt %, less than 96 wt %, less than 95 wt %, less than 90 wt %, or less than 85 wt %.

The formulations preferably comprise the another polymer (containing no AM/AV compound) as the minor component. In one embodiment, the formulation includes another polymer (containing no AM/AV compound) in an amount ranging from 10 wt % to less than 50 wt %, e.g., from 10 wt % to 49 wt %, from 10 wt % to 45 wt %, from 10 wt % to 40 wt %, from 10 wt % to 35 wt %, from 10 wt % to 30 wt %, from 10 wt % to 25 wt %, from 10 wt % to 20 wt %, or from 10 wt % to 15 wt %. In terms of lower limits, the formulation may comprise greater than 10 wt % another polymer (containing no AM/AV compound), e.g., greater than 15 wt %, greater than 20 wt %, greater than 25 wt %, greater than 30 wt %, greater than 35 wt %, greater than 40 wt %, or greater than 45 wt %. In terms of upper limits, the formulation may comprise less than 50 wt % another polymer (containing no AM/AV compound), e.g., less than 49 wt %, less than 45 wt %, less than 40 wt %, less than 35 wt %, less than 30 wt %, less than 25 wt %, less than 20 wt %, or less than 15 wt %.

Antimicrobial master batch compositions may comprise an antimicrobial compound, e.g., zinc, a zinc compound, or a zinc ion, dispersed within the antimicrobial master batch composition including the polyamide composition. In one embodiment, the antimicrobial master batch composition comprises zinc in an amount ranging from 10 wppm to 11,000 wppm, e.g., from 10 wppm to 10,000 wppm, from 10 wppm to 9000 wppm, from 10 wppm to 8000 wppm, from 10 wppm to 7000 wppm, from 10 wppm to 6000 wppm, from 10 wppm to 5000 wppm, from 10 wppm to 4000 wppm, from 10 wppm to 3000 wppm, from 500 wppm to 11,000 wppm, from 500 wppm to 9000 wppm, from 500 wppm to 8000 wppm, from 500 wppm to 7000 wppm, from 500 wppm to 6000 wppm, from 500 wppm to 5000 wppm, from 500 wppm to 4000 wppm, from 500 wppm to 3000 wppm, from 1000 wppm to 11,000 wppm, from 1000 wppm to 10,000 wppm, from 1000 wppm to 9000 wppm, from 1000 wppm to 8000 wppm, from 1000 wppm to 7000 wppm, from 1000 wppm to 6000 wppm, from 1000 wppm to 5000 wppm, from 1000 wppm to 4000 wppm, or from 1000 wppm to 3000 wppm.

In terms of lower limits, the antimicrobial master batch composition may comprise greater than 10 wppm of zinc, e.g., greater than 20 wppm, greater than 50 wppm, greater than 100 wppm, greater than 200 wppm, greater than 300 wppm, greater than 400 wppm, greater than 500 wppm, greater than 600 wppm, greater than 700 wppm, greater than 800 wppm, greater than 900 wppm, or greater than 1000 wppm.

In terms of upper limits, the antimicrobial master batch composition may comprise less than 11,000 wppm of zinc, e.g., less than 10,000 wppm, less than 9000 wppm, less than 8000 wppm, less than 7000 wppm, less than 6000 wppm, less than 5000 wppm, less than 4000 wppm, less than 3000 wppm, less than 2000 wppm, less than 1000 wppm.

In one embodiment, an antimicrobial master batch composition comprises PA6,6/6 copolymer and 2000 wppm zinc (in the form of 2500 to to 2700 ppm ZnO).

Formulations made with antimicrobial master batch compositions may comprise 50 wt % to 90 wt % antimicrobial master batch composition and 10 wt % to 50 wt % another polymer (containing no AM/AV compound). In one embodiment, a formulation comprises 50 wt % polyamide, e.g., PA6 (containing no AM/AV compound) and 50 wt % antimicrobial master batch, where the antimicrobial master batch composition comprises PA6,6/6 copolymer and 2000 wppm zinc (in the form of 2500 to 2700 ppm ZnO).

The formulation is obtained by mixing the material (polyamide continuation no AM/AV compound) and the antimicrobial master batch composition together by the blender mixer according to the appending proportion desired (e.g., to dose the antimicrobial compound as desired). An antimicrobial master batch composition and method of producing the same provides a polyamide composition suitable for films.

### Additional Components

In some embodiments, the antimicrobial film may comprise additional additives. The additives may include lubricants, antioxidants, or combinations thereof.

The antimicrobial film may optionally comprise a lubricant selected from the group consisting of aluminum distearate, zinc stearate, and calcium stearate at a concentration between 250 and 5,000 ppm, such as between 250 and 3,000 ppm, such as between 250 and 2,000 ppm, such as between 500 and 1,000 ppm, such as between 500 and 800 ppm. Other possible lubricants include, for example, N,N′-ethylene bis-steramide and stearyl erucamide at concentrations between 100 and 5,000 ppm, such as between 200 and 3,000 ppm, such as between 250 and 2,000 ppm, such as between 1,000 and 2,000 ppm, such as between 1,000 and 1,500 ppm. Also anti-block agents for film production to prevent film-to-film sticking when the film is wound tightly onto a roll may optionally be included in the antimicrobial films herein. Typically, these anti-block agents are added to lower surface energy or to create nano-level bumps that reduce the coefficient of friction of the film surface. Inorganic solids, usually in the form of diatomaceous earth, represent one class of materials that may be added to the polyamide composition. Non-limiting examples of these inorganic solids include calcium carbonate, silicon dioxide, magnesium silicate, sodium silicate, aluminum silicate, and aluminum potassium silicate. Low surface energy organic materials may also be used. In addition to the lubricants N,N′-ethylene bis-stearamide, stearyl erucamide, zinc stearate, aluminum distearate, and calcium stearate mentioned above, non-limiting examples include, glycerol monostearate.

The antimicrobial film may also optionally include organic anti-oxidants in the form of (i) hindered phenols such as, but not limited to, Irganox® 1010, Irganox® 1076 and Irganox® 1098; (ii) organic phosphites such as, but not limited to, Irgafos® 168 and Ultranox® 626; (iii) aromatic amines; (iv) metal salts from Groups IB, IIB, III, and IV of the periodic table; and (v) metal halides of alkali and alkaline earth metals. In certain embodiments, copper iodide (CuI) and potassium iodide (KI) can be present together. The organic anti-oxidants are useful as heat stabilizers.

The antimicrobial film may also optionally include nucleating agents to further improve their clarity and/or their oxygen barrier properties. Typically, these agents are insoluble, high melting point materials that provide a surface for crystallite initiation. By incorporating a nucleating agent, more crystals are initiated, which are smaller in nature. More crystallites and/or a higher % crystallinity corresponds to increased reinforcement/higher tensile strength and a more tortuous path for oxygen flux (which increases the barrier properties). Smaller crystallites decrease light scattering which corresponds to improved clarity. Non-limiting examples of nucleating agents include calcium fluoride, calcium carbonate, talc, and Nylon 2,2.

In some embodiments, the antimicrobial film may include additional antimicrobial/antiviral agents other than zinc and/or copper. The additional antimicrobial agents may be any suitable agent. Conventional antimicrobial/antiviral agents are known in the art and may be incorporated in the polyamide composition as the additional antimicrobial/antiviral agent or agents. For example, the additional antimicrobial/antiviral agent may be an entry inhibitor, a reverse transcriptase inhibitor, a DNA polymerase inhibitor, an m-RNA synthesis inhibitor, a protease inhibitor, an integrase inhibitor, or an immunomodulator, or combinations thereof. In some aspects, the additional antimicrobial agent or agents are added to the polyamide composition. In other examples, the additional antimicrobial agents may be any suitable antimicrobial, such as silver, copper, and/or gold in metallic forms (e.g., particulates, alloys and oxides), salts (e.g., sulfates, nitrates, acetates, citrates, and chlorides) and/or in ionic forms. In some aspects, further additives, e.g., additional antimicrobial agents, are added to the polyamide composition.

Film formulations would not contemplate high levels of impact modifiers, plasticizers, colorants, glass, and thus adding these components to film formulations would only add additional cost and complicate processing for little or no benefit. In embodiments herein, the amount of impact modifiers, plasticizers, colorants, glass in the polyamide compositions is less than 1000 ppm, less than 500 ppm, or less than 100 ppm. Polyamides for film applications do not include glass and are devoid or substantially devoid of glass and/or glass fibers.

These components may be considered optional. In some cases, the disclosed compositions may expressly exclude one or more of the aforementioned ingredients in this section, e.g., via claim language. For example, claim language may be modified to recite that the disclosed compositions, film formulations, processes, etc., do no utilize or comprise one of more of the aforementioned optional components. This is applicable to the many additives and/or components disclosed herein.

### Film Properties

In some cases, the use of zinc provides for processing and or end use benefits. While other antiviral agents, e.g., copper or silver, may be used, these often include adverse effects (e.g., on the relative viscosity of the polymer composition, toxicity, and health or environmental risk). In some situations, the zinc does not have adverse effects on the relative viscosity of the polyamide composition. Also, the zinc, unlike other antiviral agents, e.g., silver, does not present toxicity issues (and in fact may provide health advantages, such as immune system support). In addition, as noted herein, the use of zinc provides for the reduction or elimination of leaching into other media and/or into the environment. This both prevents the risks associated with introducing zinc into the environment and allows the polyamide composition to be reused—zinc provides surprising “green” advantages over conventional, e.g., silver-containing, compositions.

Advantageously, it has been discovered that adding the above identified zinc compounds may result in a beneficial relative viscosity (RV) of the polyamide composition for the antimicrobial film. To calculate RV, a polymer may be dissolved in a solvent (usually in formic acid), the viscosity is measured, then the viscosity is compared to the viscosity of the pure solvent. This give a unitless measurement. Solid materials, as well as liquids, may have a specific RV. The films produced from the polyamide compositions including zinc and/or copper may have the relative viscosities as described below.

In some embodiments, the RV of the antimicrobial film ranges from 80 to 280 as measured in formic acid according to ASTM D789 (9.34), e.g., from 90 to 270, from 100 to 260, from 110 to 250, from 120 to 240, from 130 to 230, from 140 to 220, from 150 to 210, from 160 to 200, or from 170 to 190. In terms of lower limits, the RV (formic) of the antimicrobial film may be greater than 80, e.g., greater than 90, greater than 100, greater than 110, greater than 120, greater than 130, or greater than 140. In terms of upper limits, the RV (formic) of the antimicrobial film may be less than 280, e.g., less than 275, less than 270, less than 265, less than 260, or less than 255. In an embodiment wherein the film comprises a polyamide composition comprising PA6,6/6, PA6,6/6,10, PA6,6/6,12, or combinations thereof, the film has a relative viscosity in formic acid according to ASTM D789 (9.34) of from 80 to 280.

In some embodiments, wherein the antimicrobial film is a cast and/or biaxially oriented polyamide film, the RV of the antimicrobial film ranges from 80 to 100 as measured in formic acid according to ASTM D789 (9.34). In other embodiments, wherein the antimicrobial film is a blown film, the RV of the antimicrobial film ranges from 130 to 170 as measured in formic acid according to ASTM D789 (9.34). The use of higher relative viscosity polyamides such as these is typically not contemplated in non-film formulations, e.g., for molded articles, which typically have a much lower relative viscosity, e.g., less than 80.

In the case of using sulfuric acid, a viscosity number (VN) is measured. In some embodiments, the a viscosity number for the film ranges from 100 cc/g to 300 cc/g as measured in sulfuric acid according to ISO 307, e.g., from 120 cc/g to 290 cc/g, from 140 cc/g to 280 cc/g, from 160 cc/g to 270 cc/g, from 180 cc/g to 260 cc/g, or from 200 cc/g to 250 cc/g. In terms of lower limits, the viscosity number (sulfuric) of the antimicrobial film may be greater than 100 cc/g, e.g., greater than 120 cc/g, greater than 140 cc/g, greater than 160 cc/g, greater than 180 cc/g, or greater than 200 cc/g. In terms of upper limits, the viscosity number (sulfuric) of the antimicrobial film may be less than 300 cc/g, e.g., less than 290 cc/g, less than 280 cc/g, less than 270 cc/g, less than 260 cc/g, or less than 250 cc/g. In an embodiment wherein the film comprises a polyamide composition comprising PA6,6/6,10, PA6,6/6,12, or combinations thereof, the film has a viscosity number in sulfuric acid according to ISO 307 of from 190 cc/g to 300 cc/g.

In some embodiments, wherein the antimicrobial film is a cast and/or biaxially oriented polyamide film, the VN of the antimicrobial film ranges from 160 cc/g to 200 cc/g as measured in sulfuric acid according to ISO 307. In other embodiments, wherein the antimicrobial film is a blown film, the VN of the antimicrobial film ranges from 230 cc/g to 290 cc/g as measured in sulfuric acid according to ISO 307.

These ranges and limits as provided above for relative viscosity and/or viscosity number are applicable to both the polyamide composition and for the antimicrobial film as a whole.

In some aspects, the number average molecular weight (Mₙ) of the antimicrobial film, or the Mₙ individually of the one or more polyamides in the antimicrobial film, can range from 20,000 g/mol to 70,000 g/mol, e.g., from 20,000 g/mol to 65,000 g/mol, from 25,000 g/mol to 65,000 g/mol, from 30,000 g/mol to 65,000 g/mol, from 35,000 g/mol to 65,000 g/mol, from 40,000 g/mol to 65,000 g/mol, or from 45,000 g/mol to 65,000 g/mol. The use of higher Mₙ polyamides such as these is typically not contemplated in conventional non-film formulations, e.g., for molded articles, which typically range from 9,000 g/mol to 20,000 g/mol.

In terms of upper limits, the antimicrobial film (or the one or more polyamides individually from which the antimicrobial film is comprised) can have a number average molecular weight less than 70,000 g/mol, e.g., less than 65,000 g/mol, less than 60,000 g/mol, less than 55,000 g/mol, less than 50,000 g/mol, less than 45,000 g/mol, less than 40,000 g/mol, less than 35,000 g/mol, or less than 30,000 g/mol. In terms of lower limits, the antimicrobial film (or the one or more polyamides individually from which the antimicrobial film is comprised) can have a number average molecular weight greater than 20,000 g/mol, e.g., greater than 25,000 g/mol, greater than 30,000 g/mol, greater than 35,000 g/mol, greater than 40,000 g/mol, or greater than 45,000 g/mol. Higher molecular weights, e.g., greater than 70,000 g/mol are also contemplated.

These ranges and limits as provided above for number average molecular weight are applicable to both the polyamide composition and for the antimicrobial film as a whole.

In certain embodiments wherein the film comprises a polyamide composition comprising PA6I/6T, the film has a viscosity number in sulfuric acid according to ISO 307 of from 80 cc/g to 150 cc/g and an Mₙ from about 9,000 g/mol to about 30,000 g/mol.

In other aspects wherein the film comprises a polyamide composition comprising PA6,10, PA6,12, or combinations thereof, the film has a viscosity number in sulfuric acid according to ISO 307 of from 100 cc/g to 300 cc/g and an Mₙ from about 13,000 g/mol to about 65,000 g/mol.

In some case, the thickness, t, of the antimicrobial film, whether a monolayer or as multiple layers stacked together, can range from 5 μm to 2 mm, e.g., from 10 μm to 1,000 μm, from 10 μm to 500 μm, from 10 μm to 400 μm, from 10 μm to 300 μm, from 10 μm to 200 μm, from 10 μm to 100 μm, from 25 μm to 1000 μm, from 25 μm to 500 μm, from 25 μm to 200 μm, from 25 μm to 100 μm, or from 25 μm to 50 μm. In terms of lower limits, the thickness of the antimicrobial film may be greater than 5 μm, e.g., greater than 10 μm, greater than 15 μm, greater than 20 μm, greater than 25 μm, greater than 50 μm, or greater than 100 μm. In terms of upper limits, the thickness of the antimicrobial film may be less than 2,000 μm, e.g., less than 1,500 μm, less than 1,000 μm, less than 500 μm, less than 200 μm, less than 100 μm, or less than 50 μm.

### Film Mechanical/Thermal/Optical Properties

Surprisingly the inventors found that zinc additions, e.g., via compounding, does not adversely affect puncture resistance and/or impact performance. In some cases, the slow rate puncture resistance of the antimicrobial film can range from 1.5 N/μm to 2.5 N/μm, e.g., from 1.6 N/μm to 2.4 N/μm, from 1.7 N/μm to 2.3 N/μm, from 1.8 N/μm to 2.3 N/μm, from 1.9 N/μm to 2.3 N/μm, or from 2.0 N/μm to 2.25 N/μm. In terms of lower limits, the slow rate puncture resistance of the antimicrobial film may be greater than 1.5 N/μm, e.g., greater than 1.6 N/μm, greater than 1.7 N/μm, greater than 1.8 N/μm, greater than 1.9 N/μm, greater than 2.0 N/μm, or greater than 2.1 N/μm. In terms of upper limits, the slow rate puncture resistance of the antimicrobial film may be less than 2.5 N/μm, e.g., less than 2.4 N/μm, or less than 2.3 N/μm. Slow rate puncture resistance is measured according to ASTM F1306.

Also surprisingly, the impact performance of the antimicrobial film, as measured by dart drop f-50, is also not adversely affected with zinc additions. In some cases, the dart drop f-50 of the antimicrobial film can be greater than 1200 g. In terms of lower limits, the dart drop f-50 of the antimicrobial film may be greater than 1200 g, e.g., greater than 1300 g, greater than 1400 g, or greater than 1500 g.

It was also observed that the zinc additions do not have any negative impacts on tensile properties, such as tensile strength and elongation at break, whether measured in cross direction (TD) or machine direction (MD). In some cases, the tensile strength of the antimicrobial film can be greater than 25,000 psi. In terms of lower limits, the tensile strength of the antimicrobial film may be greater than 25,000 psi, e.g., greater than 26,000 psi, greater than 27,000 psi, greater than 28,000 psi, greater than 29,000 psi, or greater than 30,000 psi. It was found that annealing may further improve tensile strength, particularly in the cross direction.

In some cases, the elongation at break of the antimicrobial film as measured in the cross direction can be greater than 50%. In terms of lower limits, the elongation at break (TD) of the antimicrobial film may be greater than 50%, e.g., greater than 60%, greater than 70%, greater than 80%, or greater than 90%.

In some cases, the elongation at break of the antimicrobial film as measured in the machine direction can be greater than 100%. In terms of lower limits, the elongation at break (MD) of the antimicrobial film may be greater than 100%, e.g., greater than 110%, greater than 120%, greater than 130%, or greater than 140%.

The antimicrobial films demonstrate differences of greater than 50° C. between melt temperature, Tₘₑₗₜ, and crystallization temperatures, T_{crystallization}, which is indicative of slow crystallization or a lower crystallization rate, and is beneficial in film processing. In some cases, the difference between the melt temperature Tₘₑₗₜ and the crystallization temperature T_{crystallization} of the antimicrobial film can range from 50° C. to 125° C., e.g., from 60° C. to 115° C., or from 70° C. to 105° C. In terms of lower limits, the difference between the Tₘₑₗₜ and T_{crystallization} can be greater than 50° C. e.g., greater than 60° C., greater than 70° C., greater than 80° C., or greater than 90° C. In terms of upper limits, the difference between the Tₘₑₗₜ and T_{crystallization} can be less than 125° C. e.g., less than 115° C., less than 105° C., less than 95° C., or less than 85° C.

As for optical properties, the antimicrobial film as described herein including zinc additions, can provide films wherein optical properties are maintained. In some cases, the antimicrobial film is characterized by a 45° gloss of greater than 75. In terms of lower limits, the 45° gloss of the antimicrobial film may be greater than 60, e.g., greater than 65, greater than 70, greater than 75, or greater than 80.

In some cases, the antimicrobial film is characterized by a transmission of greater than 90%. In terms of lower limits, the transmission of the antimicrobial film may be greater than 89%, e.g., greater than 89.5%, greater than 90%, greater than 90.5%, or greater than 91%.

In some cases, the antimicrobial film is characterized by a haze of greater than 14. In terms of lower limits, the haze of the antimicrobial film may be greater than 10, e.g., greater than 14, greater than 15, greater than 16, greater than 18, greater than 20, or greater than 22.

In some cases, the antimicrobial film is characterized by a clarity of greater than 94.5. In terms of lower limits, the clarity of the antimicrobial film may be greater than 94.5, e.g., greater than 95, greater than 95.5, greater than 96, or greater than 96.5.

### Antimicrobial Activity

The antimicrobial films described herein exhibit antimicrobial activity. Furthermore, other articles formed from the films may also exhibit antimicrobial properties. In particular, by utilizing a film having the polyamide composition and the aforementioned zinc compound(s) in the disclosed concentrations, an antimicrobial film exhibiting antimicrobial properties can be prepared.

In some embodiments, the films, and the articles formed therefrom, exhibit permanent, e.g., near permanent, antimicrobial properties. Said another way, the antimicrobial properties of the films last for a prolonged period of time, e.g., longer than one or more day, longer than one or more week, longer than one or more month, or longer than one or more years.

The antimicrobial properties may include any antimicrobial effect. In some embodiments, for example, the antimicrobial properties of the film work against a broad spectrum of microbes (bacteria, mold, mildew, algae, and even viruses) and the antimicrobial properties of the film include limiting, reducing, or inhibiting infection of microbes. In some cases, the antimicrobial film may limit, reduce, or inhibit both infection and pathogenesis of a microbe. As used herein, the antimicrobial film having antimicrobial properties includes any antimicrobial effect, which also includes antiviral effects.

In terms of antiviral effects, the virus affected by the antiviral properties of the antimicrobial film is not particularly limited. In some embodiments, for example, the virus is an adenovirus, a herpesvirus, an ebolavirus, a poxvirus, a rhinovirus, a coxsackievirus, an arterivirus, an enterovirus, a morbillivirus, a coronavirus, an influenza A virus, an avian influenza virus, a swine-origin influenza virus, or an equine influence virus. In some embodiments, the antiviral properties include limiting, reducing, or inhibiting the infection or pathogenesis of one of virus, e.g., a virus from the above list. In some embodiments, the antiviral properties include limiting, reducing, or inhibiting the infection or pathogenesis of multiple viruses, e.g., a combination of two or more viruses from the above list.

In some cases, the virus is a coronavirus, e.g., severe acute respiratory syndrome coronavirus (SARS-CoV), Middle East respiratory syndrome coronavirus (MERS-CoV), or severe acute respiratory syndrome coronavirus 2 (SARS-CoV-2) (e.g., the coronavirus that causes COVID-19). In some cases, the virus is structurally related to a coronavirus.

In some cases, the virus is an influenza virus, such as an influenza A virus, an influenza B virus, an influenza C virus, or an influenza D virus, or a structurally related virus. In some cases, the virus is identified by an influenza A virus subtype, e.g., H1N1, H1N2, H2N2, H2N3, H3N1, H3N2, H3N8, H5N1, H5N2, H5N3, H5N6, H5N8, H5N9, H6N1, H7N1, H7N4, H7N7, H7N9, H9N2, or H10N7.

In some cases, the virus is a the virus is a bacteriophage, such as a linear or circular single-stranded DNA virus (e.g., phi X 174 (sometimes referred to as ΦX174)), a linear or circular double-stranded DNA, a linear or circular single-stranded RNA, or a linear or circular double-stranded RNA. In some cases, the antiviral properties of the polymer composition may be measured by testing using a bacteriophage, e.g., phi X 174.

In some cases, the virus is an ebolavirus, e.g., Bundibugyo ebolavirus (BDBV), Reston ebolavirus (RESTV), Sudan ebolavirus (SUDV), Tai Forest ebolavirus (TAFV), or Zaire ebolavirus (EBOV). In some cases, the virus is structurally related to an ebolavirus.

The antiviral activity may be measured by a variety of conventional methods. For example, AATCC TM100 may be utilized to assess the antiviral activity. In one embodiment, the antimicrobial film including the polyamide composition and zinc as described herein, e.g., a film, tape, screen, and/or article formed from the film inhibits the pathogenesis (e.g., growth) of a virus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, the antimicrobial film may inhibit greater than 60% of pathogenesis of the virus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In some cases, the efficacy of the antimicrobial film may be measured in term of log reduction. For example, the films (or tapes or articles made therefrom) may demonstrate a virus log reduction greater than 1.0, as determined via ISO 21702 (modified), e.g., greater than 1.5, greater than 1.7, greater than 1.9, greater than 2.0, greater, than 3.0, greater than 4.0, or greater than 5.0.

In some embodiments, the films, and the articles formed therefrom, exhibit permanent, e.g., near permanent, antimicrobial properties. Said another way, the antimicrobial properties of the polymer composition last for a prolonged period of time, e.g., longer than one or more day, longer than one or more week, longer than one or more month, or longer than one or more years.

In terms of antimicrobial effects as relates to bacterium or bacteria, the bacterium or bacteria affected by the antimicrobial properties of the antimicrobial film is not particularly limited. In some embodiments, for example, the bacterium is a Streptococcus bacterium (e.g., Streptococcus pneumonia, Streptococcus pyogenes), a Staphylococcus bacterium (e.g., Staphylococcus aureus (S. aureus), Methicillin-resistant Staphylococcus aureus (MRSA), a Peptostreptococcus bacteria (e.g., Peptostreptococcus anaerobius, Peptostreptococcus asaccharolyticus), or a Mycobacterium bacterium, (e.g., Mycobacterium tuberculosis), a Mycoplasma bacteria (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae). In some embodiments, the antimicrobial properties include limiting, reducing, or inhibiting the infection or pathogenesis of multiple bacteria, e.g., a combination of two or more bacteria from the above list.

The antimicrobial activity may be measured by the standard procedure defined by via ISO 21702 (modified). This procedure measures antimicrobial activity by determining the percentage of a given bacterium or bacteria, e.g. S. aureus, inhibited by a tested film. In one embodiment, films formed from the polymer composition inhibit the growth (growth reduction) of Staphylococcus Aureus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, a film formed from the polymer composition may inhibit greater than 60% growth of S. aureus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In some embodiments, the antimicrobial films (or the articles made therefrom) inhibit/reduce Staph Aureus activity, as measured by via ISO 21702 (modified), by greater than 85%, e.g., greater than 86%, greater than 89%, greater than 90%, greater than 92%, greater than 95%, greater than 97%, greater than 98%, greater than 99%, greater than 99.5%, greater than 99.9%, greater than 99.99%, greater than 99.999%, greater than 99.9999%, greater than 99.99999%, or greater than 99.999999%.

In some embodiments, the antimicrobial films (or the articles made therefrom) inhibit/reduce Staph Aureus activity (colony forming units per milliliter), as measured by ASTM E35.15 WK45351. The test may be modified to employ a single specimen (1.5 grams), 15 ml neutralizer. In such cases, the antimicrobial films (or the articles made therefrom) inhibit/reduce Staph Aureus activity by greater than 13%, e.g., greater than 25%, greater than 50%, greater than 75%, greater than 80%, greater than 85%, greater than 90%, or greater than 92%.

In some embodiments, the antimicrobial films (or the articles made therefrom) inhibit/reduce Staph Aureus activity (colony forming units per milliliter), as measured by ASTM E35.15 WK45351, extracted with acetone, and then extracted using boiling water for one hour. In such cases, the antimicrobial films (or the articles made therefrom) inhibit/reduce Staph Aureus activity by greater than 75%, e.g., greater than 80%, greater than 85%, greater than 90%, greater than 95%, greater than 97%, greater than 98%, greater than 99%, greater than 99.9%, greater than 99.99%, greater than 99.999%, greater than 99.9999%, greater than 99.99999%, or greater than 99.999999%.

In some embodiments, the antimicrobial films (or the articles made therefrom) inhibit/reduce Staph Aureus activity (colony forming units per milliliter), as measured by ASTM E2149. The test may be modified to employ a single specimen (1.5 grams), 20 ml inoculum, and an 8 hour incubation time. In such cases, the antimicrobial films (or the articles made therefrom) inhibit/reduce Staph Aureus activity by greater than 50%, e.g., greater than 75%, greater than 85%, greater than 90%, greater than 95%, greater than 97%, greater than 97.5%, greater than 97.8%, greater than 98%, greater than 99%, greater than 99.9%, greater than 99.99%, greater than 99.999%, greater than 99.9999%, greater than 99.99999%, or greater than 99.999999%.

In some embodiments, the antimicrobial films (or the articles made therefrom) inhibit/reduce Staph Aureus activity (colony forming units per milliliter), as measured by ASTM E2149, extracted with acetone, and then extracted using boiling water for one hour. The test may be modified to employ a single specimen (1.5 grams), 20 ml inoculum, an 8 hour incubation time. In such cases, the antimicrobial films (or the articles made therefrom) inhibit/reduce Staph Aureus activity by greater than 50%, e.g., greater than 55%, greater than 60%, greater than 63%, greater than 75%, greater than 80%, greater than 85%, greater than 90%, greater than 92%, greater than 95%, greater than 97%, greater than 98%, greater than 99%, greater than 99.9%, greater than 99.99%, greater than 99.999%, greater than 99.9999%, greater than 99.99999%, or greater than 99.999999%.

Efficacy may be characterized in terms of log reduction. In terms of Staph Aureus log reduction, the film may be determined via ISO 21702 (modified) and may demonstrate a microbial log reduction greater than 0.8, e.g., greater than 1.0, greater than 1.5, greater than 2.0, greater than 2.5, greater than 3.0, greater than 4.0, greater than 5.0, or greater than 6.0.

In terms of Staph Aureus log reduction, the antimicrobial films (or the articles made therefrom) may be determined via ASTM 3160 (2018) and may demonstrate a microbial log reduction greater than 0.6, e.g., greater than 0.8, greater than 1.0, greater than 1.5, greater than 2.0, greater than 2.5, greater than 3.0, greater than 4.0, greater than 5.0, or greater than 6.0.

In terms of Staph Aureus log reduction, the antimicrobial films (or the articles made therefrom) may be determined via AATC 100 (2018) and may demonstrate a microbial log reduction greater than 3.0, e.g., greater than 3.5, greater than 4.0, greater than 5.5, or greater than 6.0.

The antimicrobial activity of the antimicrobial films (or the articles made therefrom) may also be measured by determining the percentage of another bacterium or bacteria, e.g. Klebsiella pneumoniae, inhibited by a tested film. In one embodiment, an antimicrobial film as described herein inhibits the growth (growth reduction) of Klebsiella pneumoniae in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 100%, from 65% to 99.999999%, from 65% to 99.99999%, from 65% to 99.9999%, from 65% to 99.999% from 65% to 99.999%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.999999%, from 75% to 99.99999%, from 75% to 99.9999%, from 75% to 99.999% from 75% to 99.999%, from 75% to 99.99%, from 75% to 99.9%, from 75% to 99%, from 75% to 98%, from 75% to 95%, %, from 80% to 100%, from 80% to 99.999999%, from 80% to 99.99999%, from 80% to 99.9999%, from 80% to 99.999% from 80% to 99.999%, from 80% to 99.99%, from 80% to 99.9%, from 80% to 99%, from 80% to 98%, or from 80% to 95%. In terms of upper limits, an antimicrobial film may inhibit less than 100% growth of Klebsiella pneumoniae, e.g., less than 99.99%, less than 99.9%, less than 99%, less than 98%, or less than 95%. In terms of lower limits, an antimicrobial film may inhibit greater than 60% growth of Klebsiella pneumoniae, e.g., greater than 65%, greater than 70%, greater than 75%, or greater than 80%, greater than 85%, greater than 90%, greater than 95%, greater than 99%, greater than 99.9%, greater than 99.99%, greater than 99.999%, greater than 99.9999%, greater than 99.99999%, or greater than 99.999999%.

In some embodiments, antimicrobial films (or the articles made therefrom) inhibit or reduce Klebsiella pneumoniae activity. The antimicrobial films (or the articles made therefrom) inhibit/reduce Klebsiella pneumoniae activity, as measured by ISO 21702 (modified), by greater than 76.1%, e.g., greater than 77%, greater than 80%, greater than 85%, greater than 90%, greater than 92%, greater than 95%, greater than 97%, greater than 98%, greater than 99%, greater than 99.5%, greater than 99.9%, greater than 99.99%, greater than 99.999%, greater than 99.9999%, greater than 99.99999%, or greater than 99.999999%.

Escherichia coli and/or Klebsiella pneumoniae efficacy may also be determined using the aforementioned tests. In some embodiments, a product formed from the polymer composition inhibits the growth (growth reduction) of Escherichia coli and/or Klebsiella pneumoniae, as measured by the test mentioned above. The ranges and limits for Staph Aureus are applicable to Escherichia coli and/or Klebsiella pneumoniae as well.

In terms of Klebsiella pneumoniae log reduction, the antimicrobial films (or the articles made therefrom) may be determined via ISO 21702 (modified) and may demonstrate a microbial log reduction greater than 0.8, e.g., greater than 0.9, greater than 1.0, greater than 1.2, greater than 1.4, greater than 1.5. greater than 2.0, greater than 2.15, greater than 2.5, greater than 2.7, greater than 3.0, greater than 3.3, greater than 4.0, greater than 5.0, or greater than 6.0.

In terms of Escherichia coli log reduction, the antimicrobial films (or the articles made therefrom) may be determined via ASTM 3160 (2018) and may demonstrate a microbial log reduction greater than 1.5, e.g., greater than 2.0, greater than 2.15, greater than 2.5, greater than 2.7, greater than 3.0, greater than 3.3, greater than 4.0, greater than 5.0, or greater than 6.0.

### Antimicrobial Film Processing

The present disclosure also relates to processes of producing the provided antimicrobial films. The antimicrobial films disclosed herein may include cast films, blown films, or biaxially oriented polyamide films. Films of polyamides, copolymers, terpolymers, blends, mixtures and/or other combinations thereof as described herein and including zine additions were prepared by melting through a single screw extruder at temperatures between 230° C. and 300° C. Cast films were prepared by extruding through a slip die and rolling onto a chilled roll through winding. Film thickness was adjusted by adjusting winding speeds and adjusting the die gap. Blown films were prepared by extruding through a circular die and blowing up through an air ring and winding into a final roll. Film thickness was controlled by adjusting the die gap, extrusion speed, stretch ratio (both machine and traverse), and by controlling the air velocity.

Multilayer blown film was prepared by using a single layer of a polyamide composition with zinc additions within a seven-layer line that consisted of seven separate extruders that feed into a stacked die to result in several multi-layer film multilayer film structures containing one to multiple layers of the polyamide resin of the present invention. In an exemplary embodiment, the components of a coextruded blown film line included: a resin feed system; extruders; a coextrusion die; an air ring; an internal pressure control for adjusting bubble diameter; a collapsing frame; a take up or haul off roll which sets the machine direction draw; a treatment system; and a winder.

The components of the polyamide composition can be mixed and blended together to produce the polyamide composition including zinc by compounding, or can be formed in situ using appropriate reactants. The terms “adding” or “combining” without further clarification are intended to encompass either the addition of the material itself to the composition or the in situ formation of the material in the composition. In some embodiments, the polyamide composition is prepared using a high solids approach from individual components rather than from individual aqueous based salts. The solids content of the first solution containing the polymer components is greater than 80%. The solution may then evaporated an evaporator.

The design features that are important in producing quality antimicrobial film at a competitive price include: an efficient and properly sized resin handling and feed system; an efficient screw design that provides a quality melt with: uniform, efficient temperature control, stable pressure; and at a high rate; an optimized die that provides good layer control and thickness uniformity, where the die is designed for ease of maintenance and durability; air rings that provide excellent cooling control and uniformity; an automated web handling system for improved efficiency and reduced change over times; modular design features for product changeovers; and integrated control systems that are intuitive, operator friendly, and that keep the process parameters on target. Detailed multi-blown film processes are described in, for example, H. F. Giles Jr. et al., Extrusion: The Definitive Processing Guide and Handbook, William Andrew Inc., Norwich, N.Y., (2005); and J. R. Wagner, Jr., Multilayer Flexible Packaging, Elsevier, (2010).

To determine critical characteristics of the antimicrobial film produced, several important process parameters were collected and studies and observations made. One key parameter is blow up ratio and draw ratio. The draw ratio in the Machine Direction (MD) is characterized by the draw down ratio (DDR), which is defined as the haul off speed divided by the polymer melt velocity as it exits the die. The blow-up ratio (BUR) characterizes the draw ratio in the Transverse Direction (TD) or hoop dimension. BUR is defined as the final bubble diameter divided by the die diameter. In addition, frost line height and process time are important parameters too. Process time, in the blown film process, is defined as the time it takes the polymer to begin to freeze once it exits the die. It is proportional to the frost line height and inversely related to haul-off speed. A key to stabilizing the bubble when preparing film with varying structures is Internal Bubble stability or control and that is controlled separately within the control systems utilized.

Antimicrobial film processing may further comprise annealing at a temperature above 60° C. The annealing may be performed in a continuous process, for example in a latter zone of the continuous process furnace with the set temperature for annealing depending upon the selected polyamide of the antimicrobial film formulation. In some embodiments, e.g., for antimicrobial films including PA66/6, PA66/610, PA66/612, or combinations thereof, the antimicrobial film is annealed at a temperature ranging from about 60° C. to about 260° C., such as from about 140° C. to about 210° C.

The annealing temperature for the antimicrobial film comprising a polyamide composition and zinc and/or copper compound may range from about 60° C. to about 260° C. In one embodiment, the annealing temperature ranges from 60° C. to 260° C., e.g., from 80° C. to 240° C., from 100° C. to 230° C., from 120° C. to 220° C., or from 140° C. to 210° C.

In terms of lower limits, the annealing temperature for the antimicrobial film may be greater than 60° C., e.g., greater than 80° C., greater than 100° C., greater than 120° C., or greater than 140° C. For certain polyamide compositions, lower annealing temperatures for the antimicrobial film are contemplated.

In terms of upper limits, the annealing temperature for the antimicrobial film may be less than 260° C., e.g., less than 240° C., less than 230° C., less than 220° C., or less than 210° C. For certain polyamide compositions, higher annealing temperatures for the antimicrobial film are contemplated. Typically the annealing step in BOPA film processing increases both tensile strength and puncture resistance.

### Applications

The antimicrobial films may be formed into multi-layer films according to application for use. In some embodiments, the antimicrobial film is a tape. Articles made from the antimicrobial films may include food packaging film, wall coverings, keypads, door push plates, touch screens, screen protectors, as well as high touch surfaces such as handrails, doorknobs, countertops, and the like.

### Exemplary Formulations

The antimicrobial film described herein will be further understood by the following exemplary formulations and embodiments.

The present disclosure relates to films that include any of the provided polyamide compositions. In one embodiment, the antimicrobial film comprises PA6,6/6, PA6,6/6,10, PA6,6/6,12, or combinations thereof and a zinc compound. The zinc compound comprises zinc oxide, zinc stearate, zinc ammonium adipate, zinc acetate, zinc pyrithione, or combinations thereof.

In some embodiments, the antimicrobial agent, e.g., zinc, is added to the polyamide composition to promote the incorporation of the antimicrobial agent into the polymer matrix of the polyamide composition. This procedure advantageously allows for more uniform dispersion of the antimicrobial agent throughout the eventual film.

In other embodiments, antimicrobial polyamide compositions comprising PA6,6/6, PA6,6/6,10, PA6,6/6,12, or combinations thereof and a zinc compound (as described above) are employed as antimicrobial master batch for compounding or otherwise processing with a polyamide, such as PA6 (containing no zinc), to provide a antimicrobial polyamide for film applications. In one example, the antimicrobial master batch of PA66/612 with a zinc content of 2500 ppm ZnO (equivalent to 2000 ppm Zn) is compounded in a ratio of 1:1 by weight with PA6 (containing no zinc) to provide a formulation PA6/PA66/612 with 1000 wppm Zn content and an antimicrobial efficacy of an antimicrobial efficacy to Staphylococcus aureus and Escherichia coli log reduction greater than 2.0, as determined by ISO 22196 (modified).

### Examples

AM/AV properties for films according to the present disclosure are shown in Tables 1 and 2. The polyamide compositions in the films in the examples below correspond as follows: Example 1 is a compounded PA6,6/6; Example 2 is a compounded PA6,6/6,12, and Example 3 is an in-situ PA6,6/6,12. The zinc content is indicated for the various samples as noted in the tables below. The zinc compound used was zinc oxide. The in-situ example, Example 3, includes that the zinc compound is introduced during polymerization. The comparative samples C1 and C2 are PA6,6/6 and are BOPA and blown films, respectively. The comparative samples contain no zinc additions.

Biaxially oriented polyamide film examples E1 and E3 exhibited anti-bacterial efficacy to Staphylococcus aureus and Escherichia coli in all instances as compared with Comparative C1, PA6,6/6 having no zinc additions.

In-situ PA6,6/612 examples (E3) demonstrated higher efficacy numbers than compounded PA66/6 examples (E1). Example E3-2, in-situ PA6,6/612 having 1000 wppm zinc, showed an anti-bacterial efficacy of log 5.

TABLE 1
Antimicrobial Activity in BOPA Films

| | | | Films | |
|---|---|---|---|---|
| | | | Bacteria | |
| | | | Staphylococcus | |
| Sample | Zn (wppm) | Polyamide | aureus | Escherichia coli |
| E1-1 | 1051 | PA6, 6/6 | 1.71 | 0.12 |
| E1-2 | 1816 | compounded | 3.1 | 1.71 |
| E3-1 | 500 | PA6, 6/6, 12 | 3.6 | 3.21 |
| E3-2 | 1000 | in-situ | 5.02 | 3.84 |
| E3-3 | 1500 | | 3.46 | 1.45 |
| C1 | 0 | PA6, 6/6 | 0.99 | 0 |

The bio-efficacy of blown films is shown in Table 2. Example 1 is compounded PA6,6/6 with samples E1-3 to E1-7 ranging in zinc content from 398 wppm to 5100 wppm. Example 2 is compounded PA6,6/6,12 with samples E2-1 to E2-4 ranging in zinc content from 605 wppm to 5842 wppm. Example 3 is in-situ PA6,6/6,12 with samples E3-4 and E3-5 having a zinc content of 656 wppm and 1427 wppm, respectively. All blown film samples demonstrated higher antimicrobial efficacy to Staphylococcus aureus as compared with Comparative C2, PA6,6/6 having no zinc additions.

TABLE 2
Antimicrobial Activity in Blown Films

| | | | Bacteria |
|---|---|---|---|
| | | | Staphylococcus |
| Sample | Zn (wppm) | Polyamide | aureus |
| E1-3 | 398 | PA6, 6/6 | 5.14 |
| E1-4 | 794 | compounded | 5.14 |
| E1-5 | 2216 | | 3.19 |
| E1-6 | 3286 | | 3.23 |
| E1-7 | 5100 | | 1.99 |
| E2-1 | 605 | PA6, 6/6, 12 | 0.53 |
| E2-2 | 1958 | compounded | 2.68 |
| E2-3 | 3589 | | 2.58 |
| E2-4 | 5842 | | 2.65 |
| E3-4 | 656 | PA6, 6/6, 12 | 3.75 |
| E3-5 | 1427 | in situ | 4.38 |
| C2 | 0 | PA6, 6/6 | 1.25 |

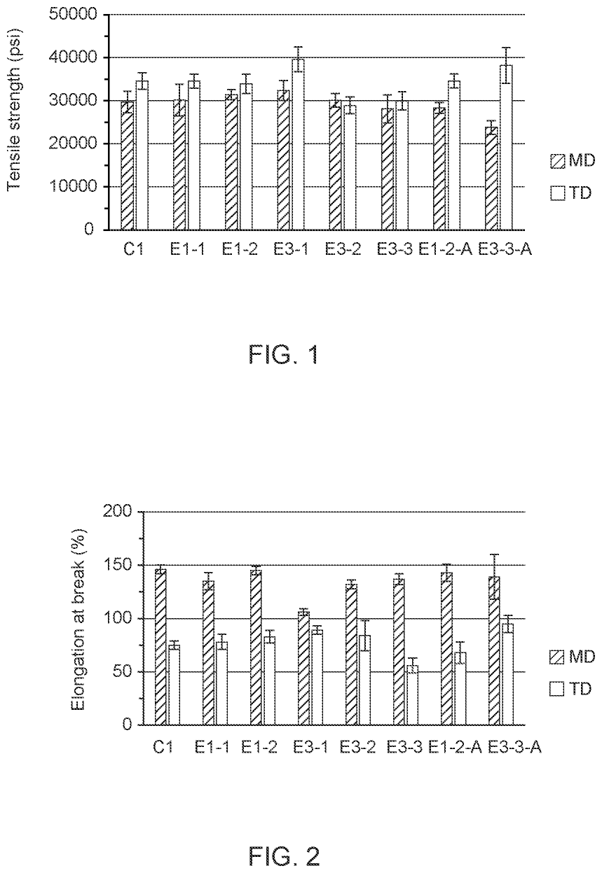

Mechanical properties are shown in FIGS. 1-4 for tensile strength, elongation at break, slow rate puncture, and dart drop f-50 for BOPA films having zinc additions. The Comparative C1, PA6,6/6 having no zinc additions, is a BOPA film as in Table 1. Examples E1-1, E1-2, E3-1, E3-2, and E3-3 are as described for Table 1. Example E1-2 further annealed at a temperature above 60° C. is Example E1-2-A. Similarly, Example E3-3 further annealed at a temperature above 60° C. is Example E3-3-A.

As demonstrated in FIGS. 1 and 2 for PA6,6/6, the addition of zinc (introduced as ZnO via compounding) does not affect either tensile strength or elongation at break, as shown by comparing C1 with E1-1 and E1-2. For PA6,6/6,12, an increase in zinc additions causes an observed decrease in tensile strength in the cross direction, yet an increase in elongation at break in the machine direction. Annealing at higher temperature appears to improve tensile strength in the cross direction as shown by comparing E1-2 with E1-2-A and by comparing E3-3 with E3-3-A as in FIG. 1. E3-1 demonstrated the highest tensile strength numbers and is indicative of higher stretch ratios, which is believe to be associated with slower crystallization rates.

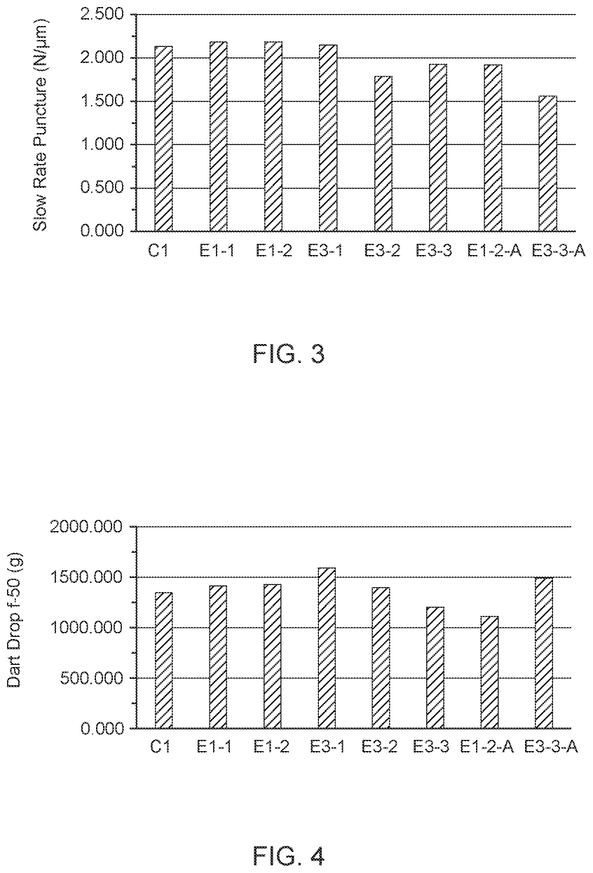

As demonstrated in FIGS. 3 and 4, for PA6,6/6 examples E1-1 and E1-2, the zinc additions via compounding does not appear to affect puncture and impact performance as compared with C1. Among PA6,6/6,12 in-situ samples, example E3-1 shows a good balance of puncture and dart prop performance.

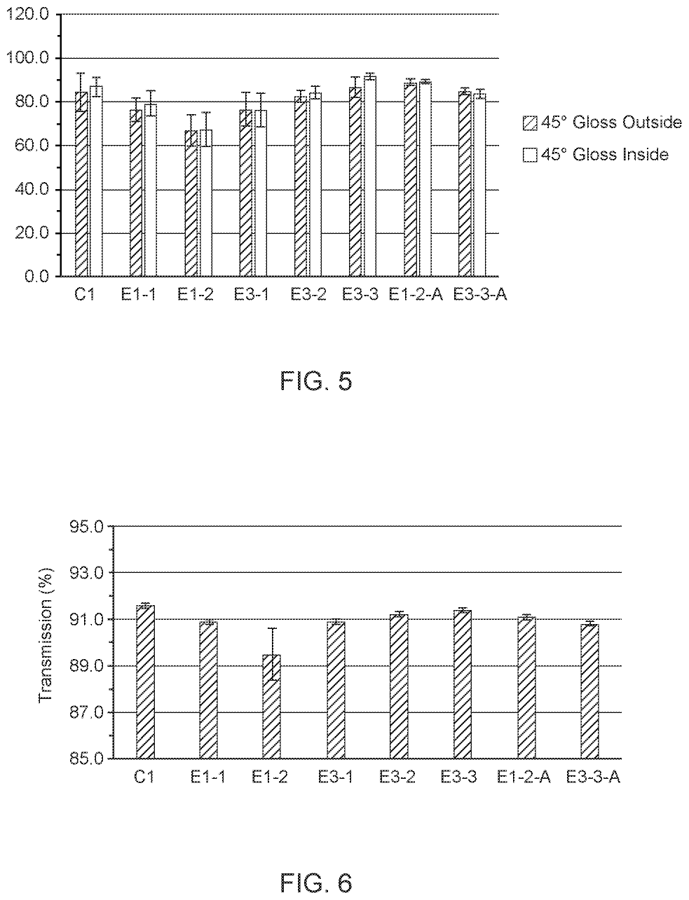

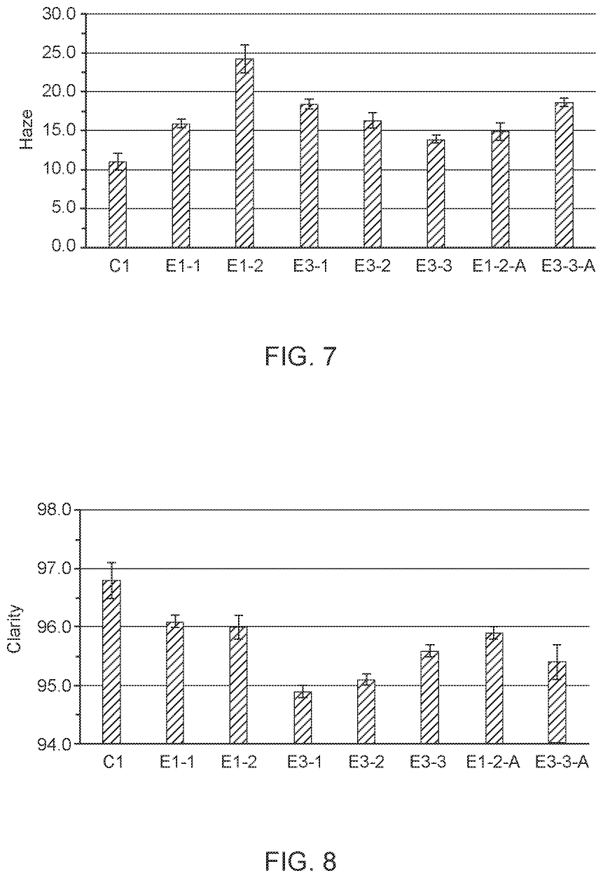

Optical properties are shown in FIGS. 5-8. Overall, the additions of zinc demonstrate optical properties can be maintained for the polyamide antimicrobial films. The increasing zinc content for the PA6,6/6 examples E1-1 and E1-2 demonstrates a decrease in gloss and transmission, yet an increase in haze. For the PA6,6/6,12 in-situ samples, E3-1 to E3-3, the zinc content does not appear to adversely affect optical properties. Generally, E3-1 to E3-3 demonstrate greater optical properties and for the compounded results than for the compounded PA6,6/6 examples E1-1 and E1-2.

The bio-efficacy of films is shown for Example 3, in situ PA6,6/6,12, as compared with commercially available comparatives C3-05. Comparatives C3-05 are non-polyamide compositions: C3, Silver Defender, a polyethylene based tape; C4, Avery® TouchGuard, a polyethylene terephthalate based tape; and C5, SurfaceGuard, a polyethylene based tape. Results are summarized in Table 3. As shown in Table 3, the inventive Example E3 performed at the highest level of percentage reduction for the bacteria Staphylococcus aureus and Escherichia coli.

TABLE 3
Antimicrobial Activity in Tapes

% Reduction

| Sample | Polymer type | S. Aureus | E. Coli |
|---|---|---|---|
| Example E3 | PA66/612 | 99.99% | >99.99% |
| C3 | PE | 97.18% | 86.22% |
| C4 | PET | 99.99% | >99.99% |
| C5 | PE | 9% | 0% |

### Embodiments

The following embodiments are contemplated. All combinations of features and embodiments are contemplated.

Embodiment 1: An antimicrobial film comprising from 50 wt % to 99.99 wt % of a polyamide composition, and from 10 wppm to 6000 wppm of zinc (and/or copper) dispersed within the film. The antimicrobial film demonstrates an antimicrobial efficacy to Staphylococcus aureus and Escherichia coli log reduction greater than 2.0, as determined by ISO 22196 (modified) and a slow rate puncture resistance greater than 1.5 N/μm as measured according to ASTM F1306.

Embodiment 2: An embodiment of embodiment 1, wherein the film comprises from 500 wppm to 3000 wppm of zinc (and/or copper) dispersed within the film.

Embodiment 3: An embodiment of embodiment 1 or 2, wherein the film comprises from 1000 wppm to 2000 wppm of zinc (and/or copper) dispersed within the film.

Embodiment 4: An embodiment of any of the embodiments of embodiment 1-3, wherein the film has a thickness less than 0.1 mm.

Embodiment 5: An embodiment of any of the embodiments of embodiment 1-4, wherein the film has a thickness less than 50 μm.

Embodiment 6: An embodiment of any of the embodiments of embodiment 1-5, wherein the film has a thickness less than 25 μm.

Embodiment 7: An embodiment of any of the embodiments of embodiment 1-6, wherein the polyamide composition comprises a polyamide selected from PA6, PA10, PA11, PA12, PA46, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA4T/4I; PA4T/6I; PA5T/5I; PA6,6/6, PA6T/6,6, PA6T/6I, PA6T/61/6, PA6T/61/6,6, PA6T/DT, PA-6T/MPMDT; PA-6T/6,10; PA10T/6,12; PA10T/10,6; PA6T/6,12; PA6T/10T; PA6T/10I; PA10T/10I; PA10T/12; PA10T/11; PA6T/9T; PA6T/12T; PA6T/10T/6I; PA6T/61/12; PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or PAMXD6; and copolymers thereof, terpolymers thereof, blends thereof, mixtures thereof, or combinations thereof.

Embodiment 8: An embodiment of any of the embodiments of embodiment 1-7, wherein the polyamide composition comprises a PA6,6-containing copolyamide.

Embodiment 9: An embodiment of any of the embodiments of embodiment 1-8, wherein the polyamide composition comprises PA6,6/6, PA6,6/6,10, PA6,6/6,12, or combinations thereof.

Embodiment 10: An embodiment of any of the embodiments of embodiment 1-9, wherein the polyamide composition comprises PA6,6/6.

Embodiment 11: An embodiment of any of the embodiments of embodiment 1-10, wherein the polyamide composition comprises PA6,6/6,10, PA6,6/6,12, or combinations thereof.

Embodiment 12: An embodiment of any of the embodiments of embodiment 1-11, wherein the polyamide composition comprises a first polyamide and a second polyamide.

Embodiment 13: An embodiment of any of the embodiments of embodiment 1-12, wherein the zinc is provided from a zinc compound comprising zinc oxide, zinc stearate, zinc ammonium adipate, zinc acetate, zinc pyrithione, or combinations thereof.

Embodiment 14: An embodiment of any of the embodiments of embodiment 1-13, wherein the copper compound comprises copper oxide, copper ammonium adipate, copper acetate, copper pyrithione, copper stearate, copper ammonium adipate, or combinations thereof.

Embodiment 15: An embodiment of any of the embodiments of embodiment 1-14, wherein the film has an Mₙ average molecular weight greater than 20,000 g/mol.

Embodiment 16: An embodiment of any of the embodiments of embodiment 1-15, wherein the film has an Mₙ average molecular weight greater than 25,000 g/mol.

Embodiment 17: An embodiment of any of the embodiments of embodiment 1-16, wherein the film has an Mₙ average molecular weight greater than 45,000 g/mol.

Embodiment 18: An embodiment of any of the embodiments of embodiment 1-17, wherein the film has an Mₙ average molecular weight from 20,000 g/mol to 65,000 g/mol.

Embodiment 19: An embodiment of any of the embodiments of embodiment 1-18, wherein the film has an Mₙ average molecular weight from 25,000 g/mol to 65,000 g/mol.

Embodiment 20: An embodiment of any of the embodiments of embodiment 1-19, wherein the film has an Mₙ average molecular weight from 45,000 g/mol to 65,000 g/mol.

Embodiment 21: An embodiment of any of the embodiments of embodiment 1-20, wherein the film has a relative viscosity in formic acid according to ASTM D789 (9.34) of from 80 to 280.

Embodiment 22: An embodiment of any of the embodiments of embodiment 1-21, wherein the film has a viscosity number in sulfuric acid according to ISO 307 of from 190 cc/g to 300 cc/g.

Embodiment 23: An embodiment of any of the embodiments of embodiment 1-22, wherein a difference between the melt temperature Tₘₑₗₜ and the crystallization temperature T_{crystallization} of the film is greater than 50° C.

Embodiment 24: An embodiment of any of the embodiments of embodiment 1-23, wherein a difference between the melt temperature Tₘₑₗₜ and the crystallization temperature T_{crystallization} of the film ranges from 50° C. to 125° C.

Embodiment 25: An embodiment of any of the embodiments of embodiment 1-24, wherein the film is a cast film, a blown film, or a biaxially oriented polyamide film.

Embodiment 26: An embodiment of any of the embodiments of embodiment 1-25, wherein the film has a tensile strength greater than 25,000 psi.

Embodiment 27: An embodiment of any of the embodiments of embodiment 1-26, wherein the film has an elongation at break greater than 50% in the cross direction (TD).

Embodiment 28: An embodiment of any of the embodiments of embodiment 1-27, wherein the film has an elongation at break greater than 100% in the machine direction (MD).

Embodiment 29: An embodiment of any of the embodiments of embodiment 1-28, wherein the film has a dart drop f-50 greater than 1200 g.

Embodiment 30: An embodiment of any of the embodiments of embodiment 1-29, wherein the film is characterized by: a 45° gloss of greater than 75; a transmission of greater than 90%; a haze of greater than 14; and a clarity of greater than 94.5.

Embodiment 31: An embodiment of any of the embodiments of embodiment 1-30, wherein the film further demonstrates an antiviral efficacy.

Embodiment 32: A process of any of the embodiments of embodiment 1-31, wherein the process comprising melting a polyamide composition including zinc in an extruder to form an antimicrobial film composition; and passing the antimicrobial film composition through a film die to form the antimicrobial film.

Embodiment 33: An embodiment of any of the embodiments of embodiment 1-32, wherein the polyamide composition including zinc (and/or copper) includes from 50 wt % to 99.99 wt % of a polyamide, and from 10 wppm to 6000 wppm of zinc (and/or copper).

Embodiment 34: An embodiment of any of the embodiments of embodiment 1-33, wherein the process further comprises biaxially orienting the antimicrobial film.

Embodiment 35: An embodiment of any of the embodiments of embodiment 1-34, wherein the process further comprises annealing at a temperature above 60° C.

Embodiment 36 is an embodiment that is an article comprising the antimicrobial film using any of embodiments 1-35, wherein the article is a tape.

Embodiment 37 is an embodiment that is an article comprising the antimicrobial film using any of embodiments 1-36, wherein the article is a food packaging film.

Embodiments 38 is an embodiment that is an antimicrobial compound for a film composition, wherein the antimicrobial compound comprises zinc present in the film composition in an amount from 10 wppm to 6000 wppm.

While the disclosure has been described in detail, modifications within the spirit and scope of the disclosure will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the disclosure and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the disclosure.

We claim:

1. An antimicrobial film comprising:
from 50 wt % to 99.99 wt % of a polyamide composition, and
from 10 wppm to 6000 wppm of zinc dispersed within the film;
wherein the film demonstrates:
an antimicrobial efficacy to Staphylococcus aureus and Escherichia coli log reduction greater than 2.0, as determined by ISO 22196 (modified), and
a slow rate puncture resistance greater than 1.5 N/μm, as measured according to ASTM F1306.

2. The antimicrobial film of claim 1, wherein the film comprises from 500 wppm to 3000 wppm of zinc dispersed within the film.

3. The antimicrobial film of claim 1, wherein the film has a thickness less than 0.1 mm.

4. The antimicrobial film of claim 1, wherein the polyamide composition comprises a polyamide selected from PA6, PA10, PA11, PA12, PA46, PA6,6, PA6,9, PA6,10, PA6,11, PA6,12, PA6,13, PA6,14, PA6,15, PA6,16, PA6,17, PA6,18, PA10,10, PA10,12, PA12,12, PA9T, PA10T, PA11T, PA12T, PA4T/4I; PA4T/6I; PAST/5I; PA6,6/6, PA6T/6,6, PA6T/6I, PA6T/61/6, PA6T/6I/6,6, PA6T/DT, PA-6T/MPMDT; PA-6T/6,10; PA10T/6,12; PA10T/10,6; PA6T/6,12; PA6T/10T; PA6T/10I; PA10T/10I; PA10T/12; PA10T/11; PA6T/9T; PA6T/12T; PA6T/10T/6I; PA6T/61/12; PA6,T/6,10, PA6,T/6,12, PA6,T/6,13, PA6,T/6,14, PA6,T/6,15, PA6,T/6,16, PA6,T/6,17, PA6,T/6,18, PA6,C/6,10, PA6,C/6,12, PA6,C/6,13, PA6,C/6,14, PA6,C/6,15, PA6,C/6,16, PA6,C/6,17, PA6,C/6,18, or PAMXD6; and copolymers thereof, terpolymers thereof, blends thereof, mixtures thereof, or combinations thereof.

5. The antimicrobial film of claim 1, wherein the polyamide composition comprises PA6,6/6, PA6,6/6,10, PA6,6/6,12, or combinations thereof.

6. The antimicrobial film of claim 1, wherein the zinc is provided from a zinc compound comprising zinc oxide, zinc stearate, zinc ammonium adipate, zinc acetate, zinc pyrithione, or combinations thereof.

7. The antimicrobial film of claim 1, wherein the film has an Mₙ average molecular weight from 20,000 g/mol to 65,000 g/mol.

8. The antimicrobial film of claim 5, wherein the film has a relative viscosity in formic acid according to ASTM D789 (9.34) of from 80 to 280.

9. The antimicrobial film of claim 4, wherein the polyamide composition comprises PA6,6/6,10, PA6,6/6,12, or combinations thereof and the film has a viscosity number in sulfuric acid according to ISO 307 of from 190 cc/g to 300 cc/g.

10. The antimicrobial film of claim 7, wherein a difference between the melt temperature Tₘₑₗₜ and the crystallization temperature T_{crystallization} of the film ranges from 50° C. to 125° C.

11. The antimicrobial film of claim 1, wherein the film is a cast film, a blown film, or a biaxially oriented polyamide film.

12. The antimicrobial film of claim 1, wherein the film has a tensile strength greater than 25,000 psi.

13. The antimicrobial film of claim 1, wherein the film has a dart drop f-50 greater than 1200 g.

14. The antimicrobial film of claim 1, wherein the film is characterized by:
a 45° gloss of greater than 75;
a transmission of greater than 90%;
a haze of greater than 14; and
a clarity of greater than 94.5.

15. A process for preparing an antimicrobial film, the process comprising:
melting a polyamide composition including zinc in an extruder to form an antimicrobial film composition; and
passing the antimicrobial film composition through a film die to form the antimicrobial film.

16. The process of claim 15, wherein the polyamide composition including zinc includes:
from 50 wt % to 99.99 wt % of a polyamide, and
from 10 wppm to 6000 wppm of zinc.

17. The process of claim 15, further comprising biaxially orienting the antimicrobial film.

18. The process of claim 15, further comprising annealing at a temperature above 60° C.

19. An article comprising the antimicrobial film of claim 1, wherein the article is a tape or a food packaging film.

20. An antimicrobial compound for a film composition, wherein the antimicrobial compound comprises zinc present in the film composition in an amount from 10 wppm to 6000 wppm.
